(19) United States
(12) Patent Application Publication
(10) Pub. No.: US 2025/0330667 A1
(43) Pub. Date: Oct. 23, 2025

(54) INFORMATION PROCESSING APPARATUS, INFORMATION PROCESSING METHOD, AND PROGRAM

(71) Applicant: Sony Group Corporation, Tokyo (JP)

(72) Inventors: Kento TAKURA, Tokyo (JP); Kumiko SO, Tokyo (JP); Tomoya KUROSAKI, Tokyo (JP)

(73) Assignee: Sony Group Corporation, Tokyo (JP)

(21) Appl. No.: 18/862,563

(22) PCT Filed: Apr. 7, 2023
(86) PCT No.: PCT/JP2023/014419

§ 371 Date: Nov. 4, 2024

(30) Foreign Application Priority Data
May 10, 2022 (JP) 2022-077572

(51) Int. Cl. H04N 21/431; H04N 21/2187; H04N 21/443; H04N 21/478

(52) U.S. Cl. CPC H04N 21/431; H04N 21/4438; H04N 21/478; H04N 21/2187

(57) ABSTRACT

An apparatus is configured to display a preset menu to preset a distribution image to be transmitted to the reception terminal before the live streaming is executed based on selections of the user. The distribution image includes a first region to be streamed the application and a second region to display other information. The preset menu includes units to preset at least one of transmission of the first region, display data for the second region, and a layout for the first region and the second region. In response to a user activation of a distribution start input, the apparatus is configured to execute the application and generate and transmit the distribution image to the reception terminal, wherein the distribution image is different from a view of the application on the apparatus.

### CROSS REFERENCE TO RELATED APPLICATIONS

This application claims the benefit of Japanese Priority Patent Application JP 2022-077572 filed on May 10, 2022, the entire contents of which are incorporated herein by reference.

### TECHNICAL FIELD

The present disclosure relates to an information processing apparatus, an information processing method, and a program. Specifically, the present disclosure relates to an information processing apparatus, an information processing method, and a program for executing and distributing a game application by a smart phone (smartphone).

### BACKGROUND ART

In recent years, many users enjoy various game applications using an information processing apparatus of a smartphone and the like.

Furthermore, the number of users who perform so-called live distribution of distributing a running game to other user terminals is also increasing.

Note that, for example, Patent Literature 1 (JP 2018-113514 A) is a related technique disclosed regarding game distribution.

In a case where the live distribution of the game is performed, a game distribution user wants a viewer as a distribution destination to view an image as intended by the game distribution user, but the image as intended by the distribution user is not necessarily distributed.

For example, image setting may be automatically changed according to regulations of a live distribution platform, and an image different from the intention of the game distribution user may be distributed.

Furthermore, there is also a problem that the game distribution user may not confirm the distribution image during the game distribution.

### CITATION LIST

### Patent Literature

PTL 1: JP 2018-113514 A

### SUMMARY

### Technical Problems

The present disclosure has been made in view of the problems described above, and for example, it is desirable to provide an information processing apparatus, an information processing method, and a program capable of easily performing preset for displaying a distribution image intended by a user on a viewer side terminal, confirmation of the distribution image, and the like in a configuration for executing and distributing a game application using a smartphone.

### Solutions to Problems

An information processing apparatus according to one aspect of the present disclosure is an information processing apparatus for live streaming an application being used by a user of the information processing apparatus from the information processing apparatus to a reception terminal. The information processing apparatus is configured to display a preset menu to preset a distribution image to be transmitted from the information processing apparatus to the reception terminal before the live streaming is executed. The distribution image includes a first region in which the application is to be streamed and a second region in which other information is to be displayed. The preset menu includes at least one of a transmission setting unit to preset transmission data for transmitting the first region to the reception terminal in response to a transmission data selection by the user, a display setting unit to preset display data for the second region in response to a display data selection by the user, and a layout setting unit to preset a layout for the first region and the second region in the distribution image in response to a layout selection by the user. The information processing apparatus is configured to display a distribution start input, wherein, in response to a user activation of the distribution start input, execute the application on the information processing apparatus, and generate and transmit the distribution image to the reception terminal. The distribution image transmitted to the reception terminal is different from a view of the application on the information processing apparatus during execution of the application.

An information processing method according to one aspect of the present disclosure is a method executed in an information processing apparatus for live streaming an application being used by a user of the information processing apparatus from the information processing apparatus to a reception terminal, the method comprising displaying a preset menu to preset a distribution image to be transmitted from the information processing apparatus to the reception terminal before the live streaming is executed. The distribution image includes a first region in which the application is to be streamed and a second region in which other information is to be displayed. The preset menu including at least one of a transmission setting unit to preset transmission data for transmitting the first region to the reception terminal in response to a transmission data selection by the user, a display setting unit to preset display data for the second region in response to a display data selection by the user, and a layout setting unit to preset a layout for the first region and the second region in the distribution image in response to a layout selection by the user. The method further includes displaying a distribution start input on the information processing apparatus, wherein, in response to a user activation of the distribution start input, executing the application on the information processing apparatus, and generating and transmitting the distribution image to the reception terminal. The distribution image transmitted to the reception terminal is different from a view of the application on the information processing apparatus during execution of the application.

A non-transitory computer readable storage according to one aspect of the present disclosure is a non-transitory computer readable storage having a program stored therein that when executed by an information processing apparatus for live streaming an application being used by a user of the information processing apparatus from the information processing apparatus to a reception terminal, causes the information processing apparatus to display a preset menu to preset a distribution image to be transmitted from the information processing apparatus to the reception terminal before the live streaming is executed. The distribution image including a first region in which the application is to be streamed and a second region in which other information is to be displayed. The preset menu includes at least one of a transmission setting unit to preset transmission data for transmitting the first region to the reception terminal in response to a transmission data selection by the user, a display setting unit to preset display data for the second region in response to a display data selection by the user, and a layout setting unit to preset a layout for the first region and the second region in the distribution image in response to a layout selection by the user. The information processing apparatus is configured to display a distribution start input, wherein, in response to a user activation of the distribution start input, execute the application on the information processing apparatus, and generate and transmit the distribution image to the reception terminal. The distribution image transmitted to the reception terminal is different from a view of the application on the information processing apparatus during execution of the application.

Note that the program of the present disclosure is, for example, a program that can be provided by a storage medium or a communication medium provided in a computer-readable format to an information processing apparatus or a computer system capable of executing various program codes. By providing such a program in a computer-readable format, processing according to the program is realized on the information processing apparatus or the computer system.

Still other objects, features, and advantages of the present disclosure will become apparent from more detailed description based on examples of the present disclosure described later and the accompanying drawings. Note that, in the present specification, a system is a logical set configuration of a plurality of devices, and is not limited to a system in which a device of each configuration is in the same housing.

According to a configuration of an embodiment of the present disclosure, an apparatus and a method for controlling each of display data and transmission data in an information processing apparatus and generating and transmitting transmission data in accordance with preset information generated by a user are realized.

Specifically, for example, a control unit that controls display data to be output to the display unit and controls transmission data to be transmitted via the communication unit is included. The control unit generates two types of images in which specifications of a display image constituting the display data and specifications of a transmission image constituting the transmission data are different. For example, an aspect ratio, a resolution, and a frame rate of the transmission data are set in advance, and the transmission data according to the setting is generated and transmitted via the communication unit.

With these pieces of processing, an apparatus and a method for controlling each of the display data and the transmission data in the information processing apparatus and generating and transmitting the transmission data according to the preset information generated by the user are realized.

Note that the effects described in the present specification are merely examples and are not limited, and additional effects may be provided.

### BRIEF DESCRIPTION OF DRAWINGS

FIG. 1 is a diagram illustrating a configuration example of an information processing system that executes and distributes a game application using an information processing apparatus.

FIG. 2 is a diagram illustrating a configuration example of the information processing system that executes and distributes the game application using the information processing apparatus.

FIG. 3 is a diagram illustrating a series of processing sequences of preset processing before game distribution, game execution, and game distribution processing in the information processing apparatus.

FIG. 4 is a diagram illustrating the series of processing sequences of the preset processing before the game distribution, the game execution, and the game distribution processing in the information processing apparatus.

FIG. 5 is a diagram illustrating the series of the processing sequences of the preset processing before the game distribution, the game execution, and the game distribution processing in the information processing apparatus.

FIG. 6 is a diagram illustrating the series of the processing sequences of the preset processing before the game distribution, the game execution, and the game distribution processing in the information processing apparatus.

FIG. 7 is a diagram illustrating the series of the processing sequences of the preset processing before the game distribution, the game execution, and the game distribution processing in the information processing apparatus.

FIG. 8 is a diagram illustrating the series of the processing sequences of the preset processing before the game distribution, the game execution, and the game distribution processing in the information processing apparatus.

FIG. 9 is a diagram illustrating a configuration example of a preset menu before data distribution (UI) displayed on an information processing apparatus (transmission terminal) used by a distribution user.

FIG. 10 is a diagram illustrating an example of a distribution game image.

FIG. 11 is a diagram illustrating a specific example of a plurality of types of distribution image setting data defined in advance.

FIG. 12 is a diagram illustrating a specific example of a thumbnail editing screen displayed on the information processing apparatus.

FIG. 13 is a diagram illustrating a specific example of a distribution image editing screen displayed on the information processing apparatus.

FIG. 14 is a diagram illustrating a specific example of editing processing using the distribution image editing screen displayed on the information processing apparatus.

FIG. 15 is a diagram illustrating a specific example of the editing processing using the distribution image editing screen displayed on the information processing apparatus.

FIG. 16 is a diagram illustrating a specific example of the editing processing using the distribution image editing screen displayed on the information processing apparatus.

FIG. 17 is a diagram illustrating a specific example of the editing processing using the distribution image editing screen displayed on the information processing apparatus.

FIG. 18 is a diagram illustrating a specific example of the editing processing using the distribution image editing screen displayed on the information processing apparatus.

FIG. 19 is a diagram illustrating a specific example of the editing processing using the distribution image editing screen displayed on the information processing apparatus.

FIG. 20 is a diagram illustrating a specific example of the editing processing using the distribution image editing screen displayed on the information processing apparatus.

FIG. 21 is a diagram illustrating a specific example of the editing processing using the distribution image editing screen displayed on the information processing apparatus.

FIG. 22 is a diagram illustrating a specific example of processing by automatically switching between a distribution image corresponding to a preset lateral layout and a distribution image corresponding to a vertical layout.

FIG. 23 is a diagram illustrating a use example of a privacy setting screen.

FIG. 24 is a diagram illustrating a specific example of an audio adjustment menu (UI) displayed on the information processing apparatus.

FIG. 25 is a diagram illustrating a specific example of a setting menu during data distribution (UI) displayed on the information processing apparatus.

FIG. 26 is a diagram illustrating a specific example of the audio adjustment menu (UI) displayed on the information processing apparatus.

FIG. 27 is a diagram illustrating switching processing as to whether the display image of the information processing apparatus is a game image being executed or a monitoring image (viewing image).

FIG. 28 is a diagram illustrating output sound switching processing according to the switching of the display image of the information processing apparatus.

FIG. 29 is a diagram illustrating an example of UI display processing in the information processing apparatus of the present disclosure.

FIG. 30 is a diagram illustrating processing of generating and distributing an image to be output to the display unit of the information processing apparatus and an image to be externally distributed as two types of images with different specifications.

FIG. 31 is a diagram illustrating an example of image output processing in a case where an information processing apparatus having a two-screen configuration is used.

FIG. 32 is a diagram illustrating an example of the image output processing in the case where the information processing apparatus having the two-screen configuration is used.

FIG. 33 is a diagram illustrating an example of voice output processing in the case where the information processing apparatus having the two-screen configuration is used.

FIG. 34 is a diagram illustrating an example of the voice output processing in the case where the information processing apparatus having the two-screen configuration is used.

FIG. 35 is a diagram illustrating an example of the voice output processing in the case where the information processing apparatus having the two-screen configuration is used.

FIG. 36 is a diagram illustrating an example of the voice output processing in the case where the information processing apparatus having the two-screen configuration is used.

FIG. 37 is a diagram illustrating an example of image output and image distribution processing in a case where the information processing apparatus having the two-screen configuration is used.

FIG. 38 is a diagram illustrating an example of the voice output processing in the case where the information processing apparatus having the two-screen configuration is used.

FIG. 39 is a diagram illustrating an example of voice output control executed by the information processing apparatus of the present disclosure.

FIG. 40 is a diagram illustrating an operation example in a case of executing voice output setting processing.

FIG. 41 is a diagram illustrating an operation example in the case of executing the voice output setting processing.

FIG. 42 is a diagram illustrating a specific example of setting processing of a voice input/output path using a voice input/output path setting unit displayed on the display unit of the information processing apparatus of the present disclosure.

FIG. 43 is a diagram illustrating a specific example of the setting processing of the voice input/output path using the voice input/output path setting unit displayed on the display unit of the information processing apparatus of the present disclosure.

FIG. 44 is a view illustrating a UI display example in a case where output sound setting processing is performed in a state where the game application is not activated.

FIG. 45 is a view illustrating a UI display example in the case where the output sound setting processing is performed in the state where the game application is not activated.

FIG. 46 is a diagram illustrating a specific processing example to which output voice control processing executed by the information processing apparatus of the present disclosure is applied.

FIG. 47 is a diagram illustrating a specific processing example to which the output voice control processing executed by the information processing apparatus of the present disclosure is applied.

FIG. 48 is a diagram illustrating a specific processing example to which the output voice control processing executed by the information processing apparatus of the present disclosure is applied.

FIG. 49 is a diagram illustrating a specific processing example to which the output voice control processing executed by the information processing apparatus of the present disclosure is applied.

FIG. 50 is a diagram illustrating a configuration example of an information processing apparatus of the present disclosure.

FIG. 51 is a diagram illustrating a hardware configuration example of an apparatus that can be used as the information processing apparatus or a server of the present disclosure.

### DESCRIPTION OF EMBODIMENTS

Hereinafter, an information processing apparatus, an information processing method, and a program of the present disclosure will be described in detail with reference to the drawings. Note that the description will be made according to the following items.
1. Execution and distribution processing example of game application in information processing apparatus
2. Series of processing sequences of presetting processing before data distribution, data distribution processing, and setting processing during data distribution executed in information processing apparatus of present disclosure
3. Details of configuration of preset menu before data distribution (UI) and distribution data setting processing using preset menu before data distribution (UI)
4. Details of configuration of setting menu during data distribution (UI) and distribution data setting processing using setting menu during data distribution (UI)
5. Other functions of information processing apparatus of present disclosure
5-1.(1) UI display function for screen other than game execution screen
5-2.(2) Function of generating own device output image and distribution image as images of different modes.
5-3.(3) Processing function in case where information processing apparatus (transmission terminal) 100 has two-screen configuration
6. Voice output control processing of information processing apparatus
7. Configuration example of information processing apparatus
8. Hardware configuration example of information processing apparatus and server
9. Summary of configuration of present disclosure
   (1. Execution and Distribution Processing Example of Game Application in inFormation Processing Apparatus)

First, an example of execution and distribution processing of a game application in an information processing apparatus will be described.

Specifically, the information processing apparatus of the present disclosure is, for example, a smart phone (smartphone), and is an apparatus capable of performing communication via a network of the Internet and the like.

The information processing apparatus of the present disclosure is, for example, a device capable of performing video distribution via a network or content distribution such as game content or music content by execution of a game application (application).

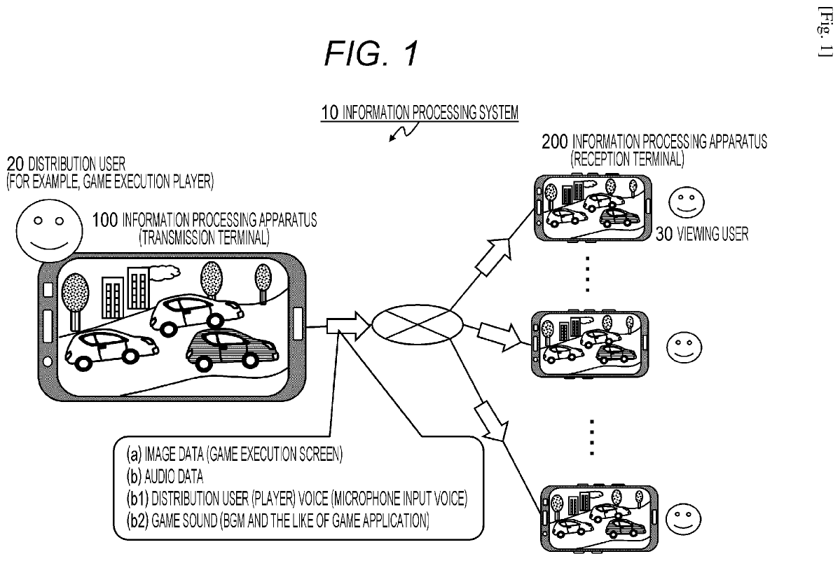

FIG. 1 illustrates a configuration example of an information processing system 10 using the information processing apparatus of the present disclosure.

The information processing apparatus (transmission terminal) 100 is a terminal of a distribution user (for example, a game execution player) 20. The distribution user (for example, a game execution player) 20 executes a game application (application) using the information processing apparatus (transmission terminal) 100.

The content including a game application screen, a game application voice (application voice), and the like is distributed to an information processing apparatus (reception terminal) 200 of a viewing user 30 via a network such as the Internet.

The application voice is, for example, BGM generated by the application or various voices generated in the game application. For example, the example illustrated in the drawing is a game application of an automobile race, and the application voice includes various audios such as an engine sound of an automobile, a cheer of an audience, and a collision sound at the time of a crash.

Moreover, the user who executes the game using the information processing apparatus (transmission terminal) 100, that is, the distribution user 20 makes a gaming commentary of the game being executed. That is, the voice of the distribution user 20 is input via a microphone of the information processing apparatus (transmission terminal) 100, and the description of the game, the description of the situation, and the like are performed.

The voice of the distribution user 20 is transmitted to the information processing apparatus (reception terminal) 200 on the viewing user 30 side together with the above-described application voice, and is reproduced on the information processing apparatus (reception terminal) 200 side.

Moreover, the viewing user 30 can input a comment such as a support message as text to the information processing apparatus (reception terminal) 200, and the input comment is transmitted to the information processing apparatus (transmission terminal) 100 on the distribution user 20 side via the network.

The information processing apparatus (transmission terminal) 100 on the distribution user 20 side converts the received comment from the information processing apparatus (reception terminal) 200 into audio data to generate a comment voice, and synthesizes (mixes) the generated comment voice together with the application voice and the voice of the game execution user to distribute.

Note that the viewing user 30 may directly input the comment such as the support message by voice via the microphone of the information processing apparatus (reception terminal) 200. In this case, the input voice comment is transmitted to the information processing apparatus (transmission terminal) 100 on the distribution user 20 side via the network.

The information processing apparatus (transmission terminal) 100 on the distribution user 20 side combines (mixes) the voice comment received from the information processing apparatus (reception terminal) 200 together with the application voice or the voice of the game execution user and distributes the combined voice comment.

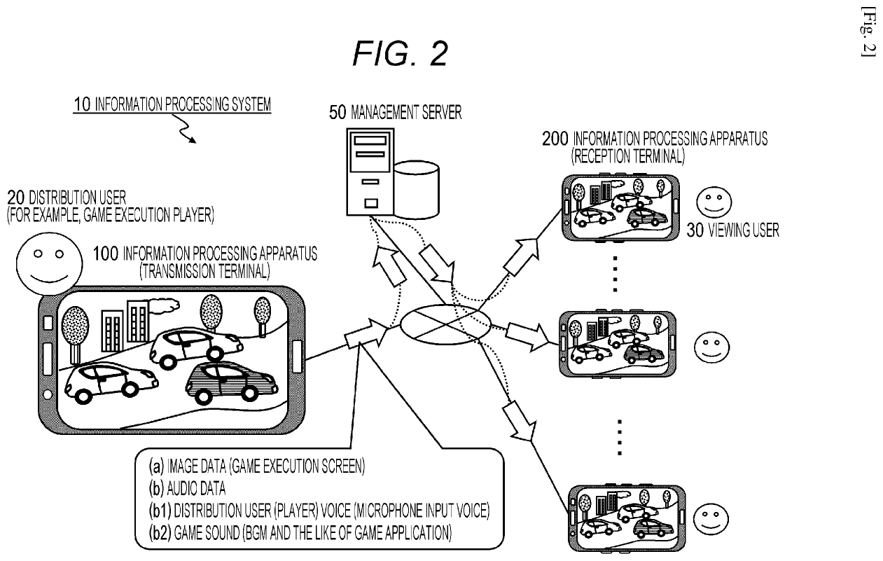

Note that the information processing system 10 in FIG. 1 is a configuration example of a system that directly transmits and receives data between the information processing apparatus (transmission terminal) 100 and the plurality of information processing apparatuses (reception terminals) 200. However, for example, as illustrated in FIG. 2, data transmission and reception may be performed via a management server 50 on the network.

In the configuration illustrated in FIG. 2, the information processing apparatus (transmission terminal) 100 on the distribution user 20 side transmits data to the management server 50. The information processing apparatus (reception terminal) 200 on the viewing user 30 side receives this data from the management server 50 and views the data.

Even in such a system configuration, the information processing apparatus (transmission terminal) 100 on the distribution user 20 side synthesizes the execution screen data of the game application, the application voice such as the BGM of the game application, the voice of the game execution user, the comment voice of the viewing user, and the audio data of the plurality of different sound sources and transmits the synthesized data to the management server 50. The information processing apparatus (reception terminal) 200 on the viewing user 30 side receives the synthesized audio data together with the image data from the management server 50 and views the same.

### (2. Series of Processing Sequences of Presetting Processing Before Data Distribution, Data Distribution Processing, and Setting Processing During Data Distribution Executed in Information Processing Apparatus of Present Disclosure)

Next, a series of processing sequences of presetting processing before data distribution, data distribution processing, and setting processing during data distribution executed in the information processing apparatus of the present disclosure will be described.

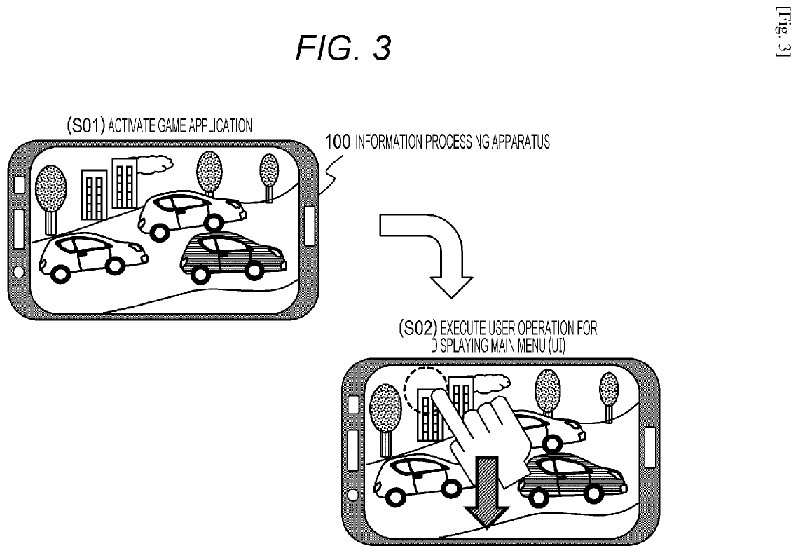

With reference to FIGS. 3 to 8, the presetting processing before data distribution, the series of processing sequences of the presetting processing before data distribution, the data distribution processing, and the setting processing during data distribution executed by the information processing apparatus 100 which is the transmission terminal on the distribution user 20 side executing and distributing the game will be described.

FIGS. 3 to 8 sequentially illustrate processing executed by the information processing apparatus 100 (transmission terminal) on the distribution user 20 side as the following time-series processing (S01 to S11).
(S01) Activate game application
(S02) Execute user operation for displaying main menu (UI: user interface)
(S03) Display main menu (UI)
(S04) Operate (tap) recording & stream icon (Rec & stream) in main menu
(S05) preset menu before data distribution (UI) screen is displayed.
(S06) Operate completion (Ready) icon after distribution presetting on preset menu before data distribution (UI) screen
(S07) Final check screen before distribution start is displayed
(S08) Operate distribution start (Go Live) icon on distribution start final check screen
(S09) Switch to game execution screen and start distribution
(S10) Execute setting menu during data distribution (UI) display operation during game execution & distribution processing
(S11) setting menu during data distribution (UI) corresponding to game execution distribution period is displayed.

Each of these processes will be sequentially described below.

(Step S01) First, the distribution user 20 activates the game application in the information processing apparatus (transmission terminal) 100 in Step S01 illustrated in FIG. 3.

### (Step S02)

Next, in Step S02, the distribution user 20 executes a user operation for displaying the main menu (UI: user interface) on the information processing apparatus 100.

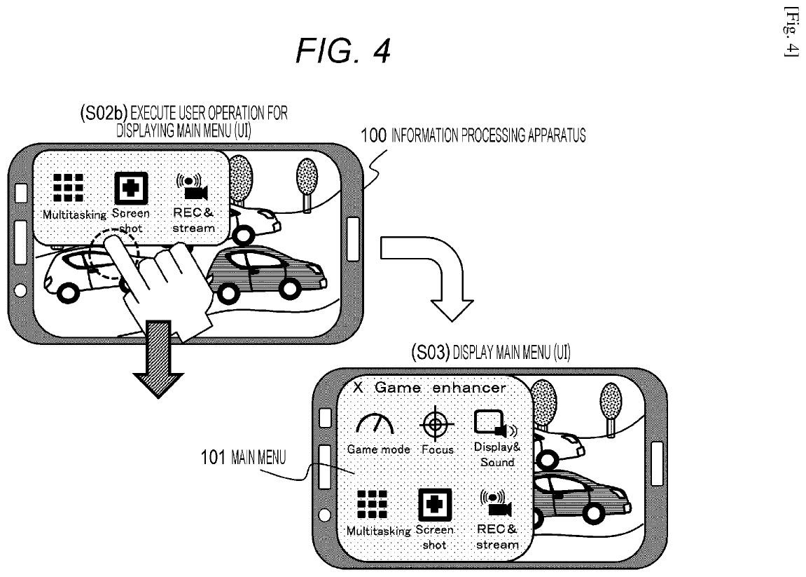

For example, as illustrated in FIG. 3 (S02), by performing flick processing of sliding a finger from the upper part toward the lower part of the screen of the information processing apparatus 100, the main menu is gradually pulled out from the upper part and displayed as illustrated in FIG. 4 (S02b).

Note that the flick processing is an example of a user operation for displaying the main menu, and other user operations may be used.

### (S03)

Upon completion of the flick processing of sliding the finger from the upper part toward the lower part of the screen of the information processing apparatus 100, a main menu (UI) 101 is displayed on a display unit of the information processing apparatus 100 as illustrated in step (S03) in the lower right of FIG. 4.

The main menu 101 includes various operation icons.

Note that, in the main menu 101 illustrated in FIG. 4, a plurality of icons of a game mode (Game mode), a focus setting (Focus), a display unit and audio setting (Display & Sound), multitasking (Multitasking), a screen shot (Screen shot), and a recording & stream (REC & stream) are set.

The user can perform processing associated with each icon or processing of displaying another menu associated with the icon by operating (tapping) any one of these icons.

Note that the example of the icons illustrated in the drawing is an example, and in addition to this, various icons can be displayed in the main menu, and for example, various operation icons corresponding to the game application are displayed.

### (Step S04)

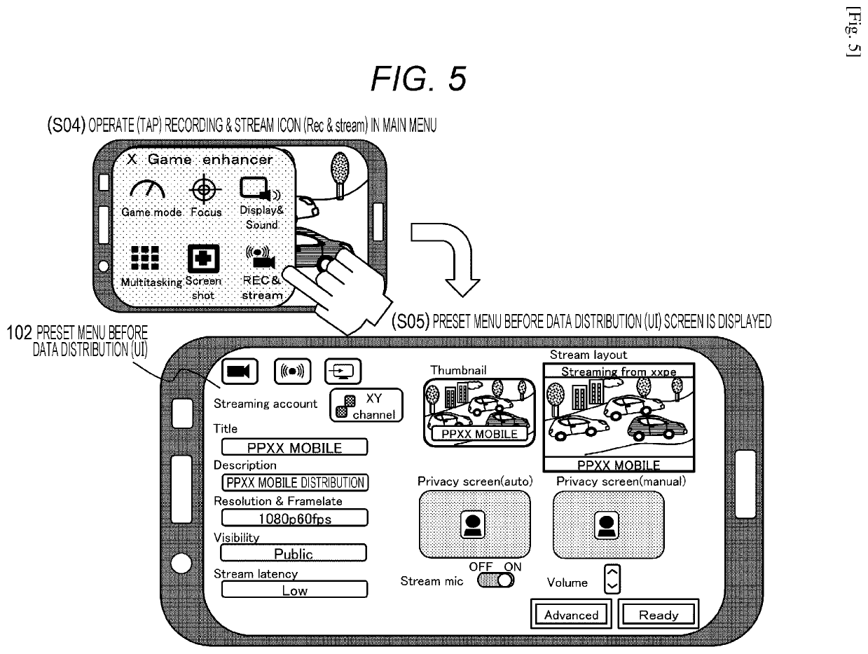

Step S04 illustrated in FIG. 5 is an icon operation processing step for causing the distribution user 20 to execute the processing of the present disclosure.

That is, the processing in which the distribution user 20 selects and operates (taps) the recording & stream icon (Rec & stream) displayed in the main menu 101 is illustrated.

### (Step S05)

In Step S04, when the distribution user 20 operates (taps) the record & stream icon (Rec & stream) displayed in the main menu 101, a preset menu before data distribution (UI) (user interface) 102 as illustrated in the lower part of FIG. 5 is displayed.

The preset menu before data distribution (UI) 102 is a UI for performing various settings related to distribution data such as setting of a game image to be distributed before the distribution user 20 performs game distribution.

Details of the preset menu before data distribution (UI) 102 and details of preset processing using the UI will be described later.

### (Step S06)

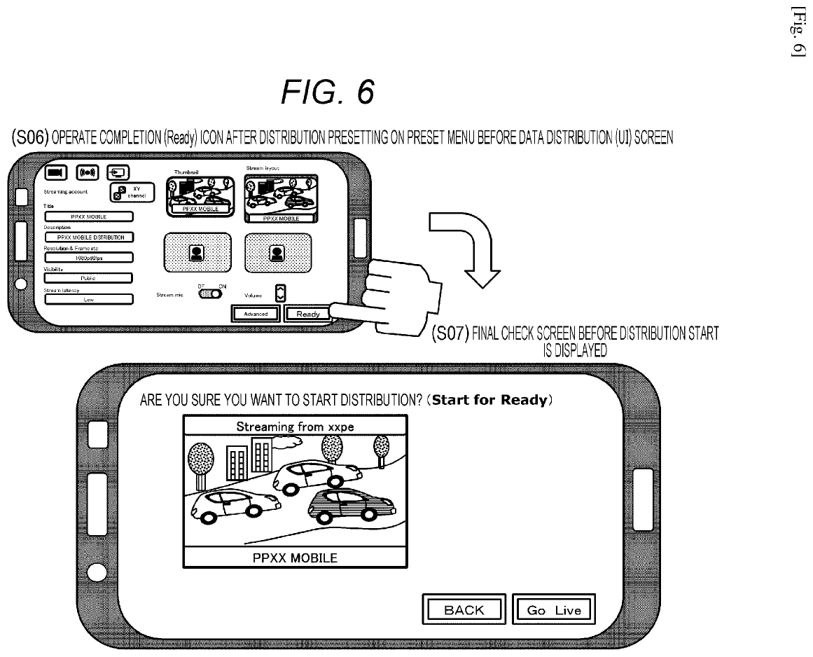

When the distribution user 20 completes setting of the image of the distribution game and the like using the preset menu before data distribution (UI) 102 illustrated in FIG. 5, the distribution user 20 operates a setting completion (Ready) icon in the preset menu before data distribution (UI) 102 as illustrated in (Step S06) of FIG. 6.

### (Step S07)

In Step S06, when the distribution user 20 operates a setting completion (Ready) icon in the preset menu before data distribution (UI) 102, a “final check screen before distribution start” as illustrated in the lower part of FIG. 6 is displayed.

An example of the distribution game image generated by the distribution user 20 using the preset menu before data distribution (UI) 102 illustrated in FIG. 5 is displayed on the “final check screen before distribution start”.

The distribution user 20 confirms the image, and when yes, operates a “Go Live” operation unit at the lower part of the screen.

Meanwhile, in a case where the user is not satisfied with the displayed distribution game image or in a case where the user desires to perform other correction, the user operates the “back (BACK)” operation unit. By operating the “back (BACK)” operation unit, the preset menu before data distribution (UI) 102 illustrated in FIG. 5 (S05) is displayed again, and resetting and the like of various distribution data can be performed.

### (Step S08)

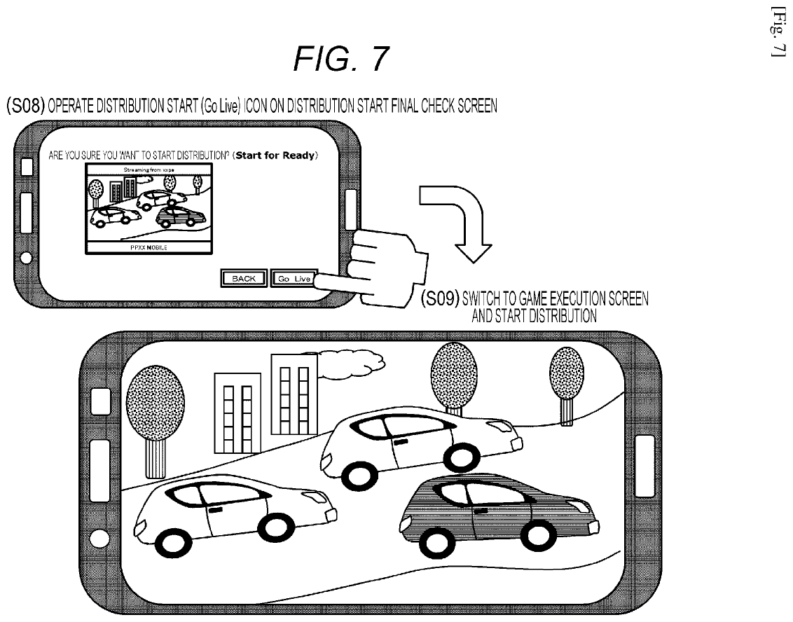

When the distribution user 20 accepts the example of the distribution game image displayed on the “final check screen before distribution start”, the distribution user 20 operates the distribution start (Go Live) icon on the distribution start final check screen as illustrated in FIG. 7 (S08).

### (Step S09)

When the distribution user 20 operates the distribution start (Go Live) icon on the distribution start final check screen as illustrated in FIG. 7 (S08), the display data on the display unit of the information processing apparatus 100 is switched to the game execution screen as illustrated in FIG. 7 (S09), and the distribution is started.

At this time, the image (distribution game image) distributed from the information processing apparatus 100 is a distribution game image generated by the distribution user 20 using the preset menu before data distribution (UI) (user interface) 102. That is, an image according to the example of the distribution game image displayed on the “final check screen before distribution start” illustrated in FIG. 6 is transmitted.

### (Step S10)

Thereafter, the distribution user 20 executes the game application using the information processing apparatus 100. The live distribution of the game being executed in parallel with the execution of the game application is executed.

In the game execution and distribution period, the distribution user 20 can operate the information processing apparatus 100 to display the setting menu during data distribution (UI).

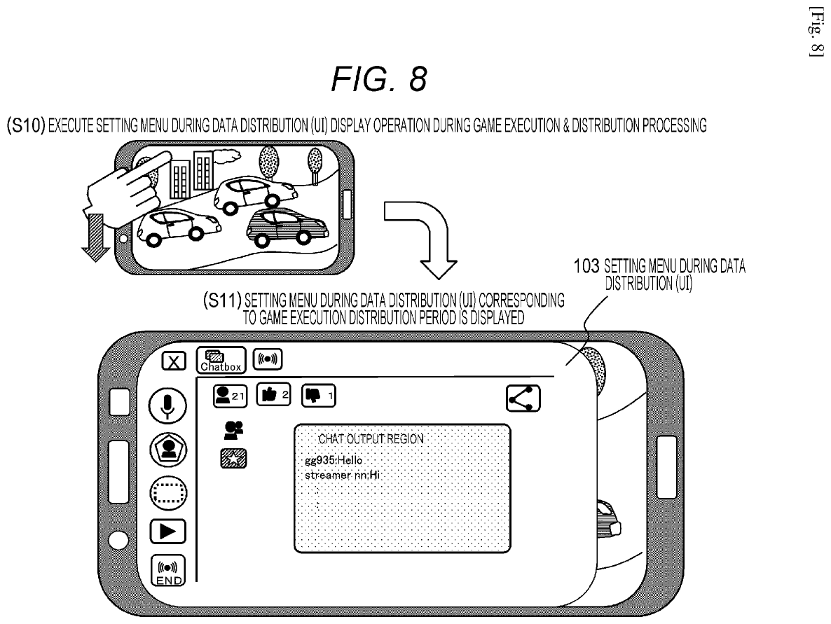

Step (S10) in FIG. 8 illustrates this user operation example.

For example, as illustrated in FIG. 8 (S10), the distribution user 20 performs flick processing of sliding a finger from the upper part to the lower part of the screen of the information processing apparatus 100. By this processing, the setting menu during data distribution (UI) is displayed.

Note that the flick processing is an example of the user operation for displaying the setting menu during data distribution (UI), and other user operations may be used.

### (Step S11)

In Step S10, the distribution user 20 performs an operation for displaying the setting menu during data distribution (UT) on the information processing apparatus 100, for example, the flick processing, so that a setting menu during data distribution (UI) 103 corresponding to the game execution distribution period is displayed as illustrated in FIG. 8 (S11).

The setting menu during data distribution (UI) 103 is provided with an operation unit for executing change of data during distribution, for example, voice adjustment processing, and the distribution user 20 can perform setting using these operation units.

Furthermore, the setting menu during data distribution (UI) 103 includes a chat output region, and chat information of the distribution user 20 or the viewing user 30 viewing the live distribution game is displayed on the chat output region.

A detailed configuration and a usage example of the setting menu during data distribution (UI) 103 will be described later.

### (3. Details of Configuration of Preset Menu Before Data Distribution (UI) and Distribution Data Setting Processing Using Preset Menu Before Data Distribution (UI))

Next, the details of the configuration of the preset menu before data distribution (UI) and the distribution data setting processing using the preset menu before data distribution (UI) will be described.

As described above with reference to FIG. 5, in Step S04 illustrated in FIG. 5, when the distribution user 20 operates (taps) the recording & stream icon (Rec & stream) displayed in the main menu 101, the preset menu before data distribution (UI) (user interface) 102 as illustrated in the lower part of FIG. 5 is displayed.

The preset menu before data distribution (UI) (user interface) 102 is a UI for performing various settings related to distribution data such as setting of a game image to be distributed before the distribution user 20 distributes a game.

Hereinafter, a detailed configuration of the preset menu before data distribution (UI) (user interface) 102 and details of the distribution data setting processing using the preset menu before data distribution (UI) 102 will be described.

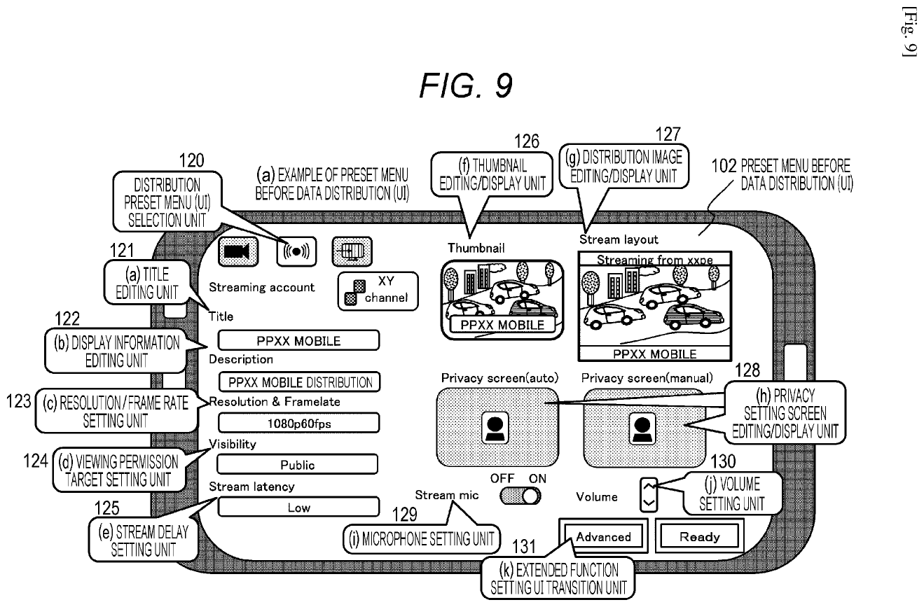

FIG. 9 illustrates an example of a preset menu before data distribution (UI) 102 displayed on the information processing apparatus (transmission terminal) 100 used by the distribution user 20.

Note that the preset menu before data distribution (UI) 102 illustrated in FIG. 9 is displayed, for example, by selecting a distribution preset menu (UI) selection unit 120 at the upper left end, and icons on both sides thereof are selected when displaying different menus (UI).

As illustrated in FIG. 9, the following processing units that can be operated by the user are displayed in the preset menu before data distribution (UI) 102.
(a) Title editing unit 121
(b) Display information editing unit 122
(c) Resolution/frame rate setting unit 123
(d) Viewing permission target setting unit 124
(e) Stream delay setting unit 125
(f) Thumbnail editing/display unit 126
(g) Distribution image editing/display unit 127
(h) Privacy setting screen editing/display unit 128
(i) Microphone setting unit 129
(j) Volume setting unit 130
(k) Extended function setting UI transition unit 131

The “(a) title editing unit 121” is a region for writing and editing the title of the game distributed by the distribution user 20.

The distribution user 20 can freely set the title of the distribution game.

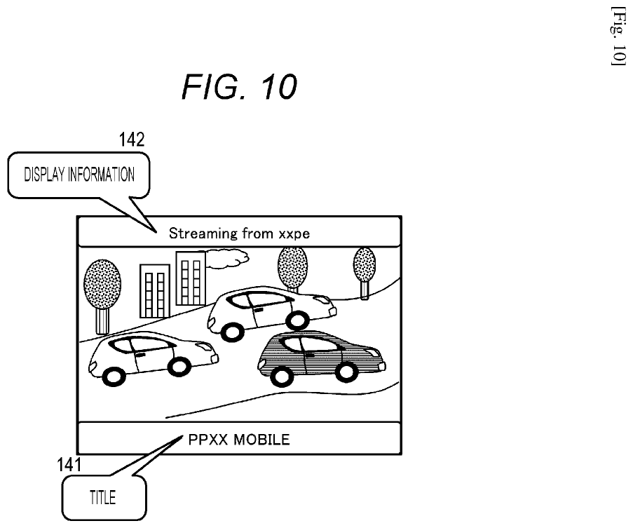

Note that this title is distributed together with the live distribution image, for example. An example of the distribution game image is illustrated in FIG. 10.

As illustrated in FIG. 10, the distribution image includes a title 141 and display information 142 together with the image of the game application being executed by the distribution user 20.

The display information 142 illustrated in FIG. 10 is an example of display information including, for example, a type, name, and the like of the distribution terminal on which the game distribution is being executed. Note that the title 141 and the display information 142 can be freely set by the distribution user 20.

As described above, the information processing apparatus (reception terminal) 200 on the viewing user 30 side can include not only the game application image being executed by the distribution user 20 but also the title 141 and the display information 142 set by the distribution user 20.

Note that the layout of the distribution image illustrated in FIG. 10 is an example, and the layout of the distribution image can be changed and edited to various different layouts. This layout editing will be described later.

The “(b) display information editing unit 122” is a region for editing data to be displayed in the display region of the display information 142 described with reference to FIG. 10.

The distribution user 20 can freely set the display information to be displayed together with the game live image to be distributed.

For example, as described with reference to FIG. 10, for example, the display information including the type, name, and the like of the distribution terminal on which the game distribution is being executed is generated. Note that, as described above, the distribution user 20 can freely set the display information.

The “(c) resolution/frame rate setting unit 123” is a region in which the resolution, the frame rate, and the aspect ratio of the live distribution game image are set. The user can select one piece of setting information from a plurality of types of distribution image setting data defined in advance.

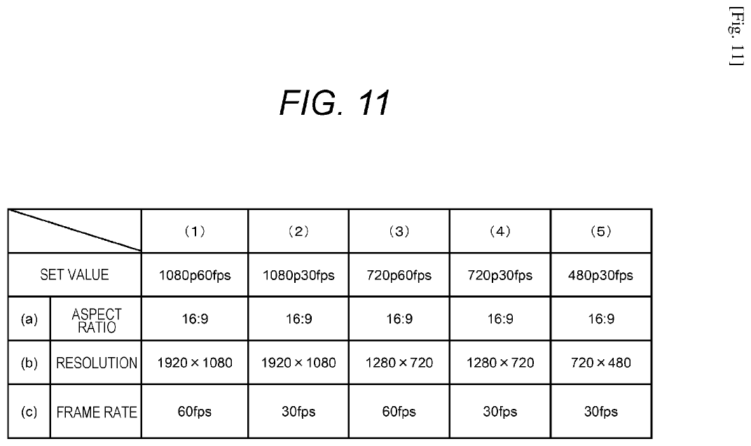

Specifically, for example, one of the following five types of settings ((1) to (5)) illustrated in FIG. 11 can be selected and set.

$$1080 p 60 fps = aspect ratio ( 16 : 9 ) , \\ resolution ( 1920 \times 1080 ) , frame rate ( 60 fps ) \qquad ( 1 )$$

$$1080 p 30 fps = aspect ratio ( 16 : 9 ) , \\ resolution ( 1920 \times 1080 ) , frame rate ( 30 fps ) \qquad ( 2 )$$

$$720 p 60 fps = aspect ratio ( 16 : 9 ) , \\ resolution ( 1280 \times 720 ) , frame rate ( 60 fps ) \qquad ( 3 )$$

$$720 p 30 fps = aspect ratio ( 16 : 9 ) , \\ resolution ( 1280 \times 720 ) , frame rate ( 330 fps ) \qquad ( 4 )$$

$$480 p 30 fps = aspect ratio ( 16 : 9 ) , \\ resolution ( 720 \times 480 ) , frame rate ( 30 fps ) \qquad ( 5 )$$

The information processing apparatus (transmission terminal) 100 generates a live distribution image according to the information set by the distribution user 20 to the “(c) resolution/frame rate setting unit 123”, that is, a live distribution image having the resolution, the frame rate, and the aspect ratio set by the user, and transmits the live distribution image via a transmission unit.

Returning to FIG. 9, the description of each component of the preset menu before data distribution (UI) will be continued.

The “(d) viewing permission target setting unit 124” is a region in which the restriction information on the viewing user who can view the distribution live image is recorded.

Specifically, it is possible to set one of the following: allowing viewing without limitation (Public), allowing viewing only for a specific user (Unlisted), and allowing viewing only for a designated user (Private).

The “(e) stream delay setting unit 125” is a region in which allowable delay information of a live distribution data stream to be distributed is recorded, and three types of settings of normal (Normal), low (Low), and ultra-low (Ultra-low) can be made.

The “(f) thumbnail editing/display unit 126” is a region for displaying, for example, editing processing of a thumbnail to be displayed on the distribution game list data provided by the distribution management server and a thumbnail as an editing result.

In a case where the distribution user 20 desires to edit the thumbnail, this “(f) thumbnail editing/display unit 126” is operated (for example, tapped).

By this user operation, a thumbnail editing screen is displayed.

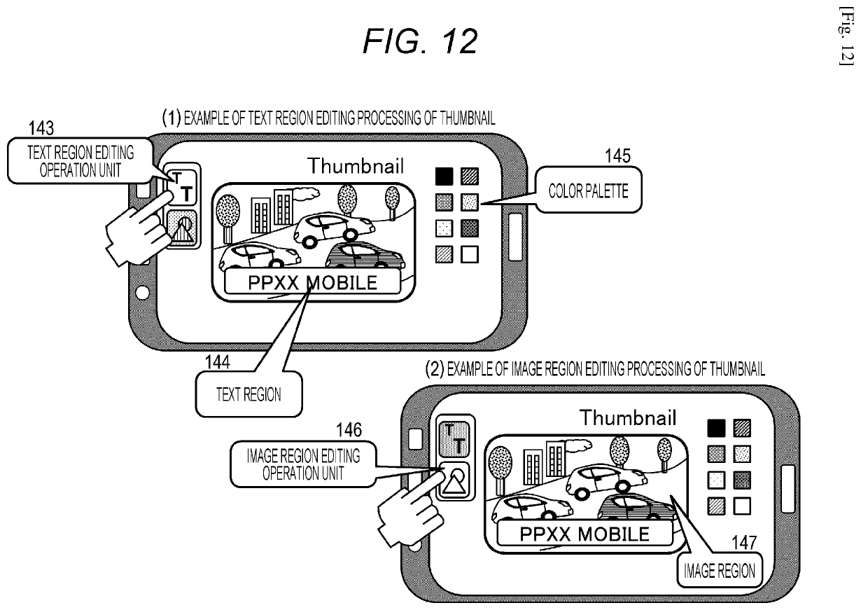

Specifically, for example, a thumbnail editing screen as illustrated in FIG. 12 is displayed.

FIG. 12 illustrates the following two diagrams.
(1) Example of text region editing processing of thumbnail
(2) Example of image region editing processing of thumbnail

The text region of the thumbnail is a text region 144 in which a game title and the like are displayed as illustrated in FIG. 12(1).

In a case where the text region 144 is edited, the user operates (taps) a text region editing operation unit 143. By this operation, the text region 144 can be edited.

For example, characters, sizes, colors, positions, and the like to be output to the text region 144 can be set. For example, by selecting a desired color from a color palette 145, it is possible to set and change a color of the text, a color serving as a background of the text, and the like.

Furthermore, the image region of the thumbnail is an image region 147 in which a game image is displayed as illustrated in FIG. 12(2).

In a case where the image region 147 is edited, the user operates (taps) an image region editing operation unit 146. With this operation, the image region 147 can be edited.

For example, the size, position, and the like of the image region 147 can be set.

Returning to FIG. 9, the description of each component of the preset menu before data distribution (UI) will be continued.

The “(g) distribution image editing/display unit 127” is a region where editing processing and display processing of a layout and the like of a distribution image distributed from the information processing apparatus (transmission terminal) 100 are performed.

In a case where the distribution user 20 desires to edit the distribution image, this “(g) distribution image editing/display unit 127” is operated (for example, tapped).

By this user operation, the distribution image editing screen is displayed.

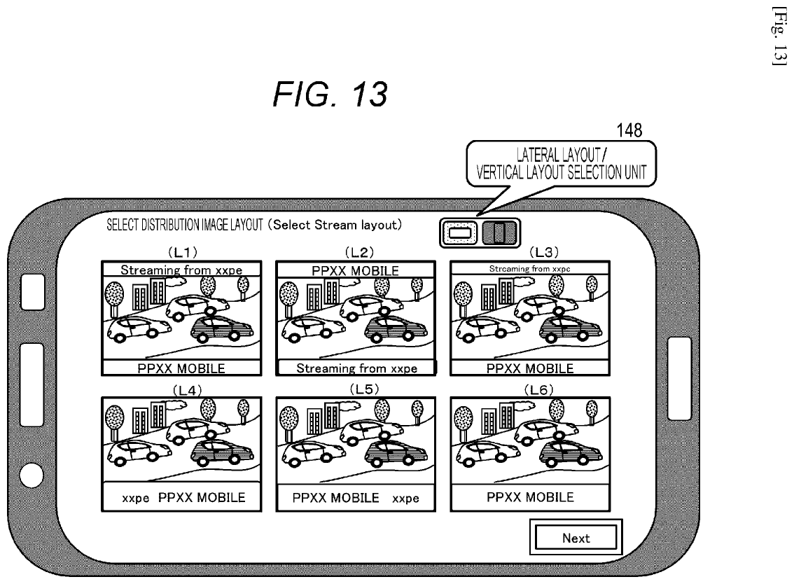

Specifically, for example, a distribution image editing screen as illustrated in FIG. 13 is displayed.

An example of distribution image editing processing will be described with reference to FIG. 13 and subsequent drawings.

First, layout selection processing of the distribution image is performed. As illustrated in FIG. 13, a plurality of different distribution image layouts is displayed on the display unit of the information processing apparatus (transmission terminal) 100.

In the example illustrated in FIG. 13, six types of distribution image layouts (L1) to (L6) are displayed.

Note that the example of the distribution image layout illustrated in FIG. 13 is a lateral layout, in other words, an example of a layout of a distribution image when the distribution user 20 holds the information processing apparatus (transmission terminal) 100 laterally (horizontally long), plays a game, and distributes the distribution image, and is displayed in a case where the left lateral layout is selected from a lateral layout/vertical layout selection unit 148 in the upper part of FIG. 13.

In a case where the right vertical layout is selected from the lateral layout/vertical layout selection unit 148, an example of the layout of the distribution image when the information processing apparatus (transmission terminal) 100 is held laterally (horizontally long), a game is played, and distribution is performed is displayed. An example of the vertical layout will be described later.

The game title and the display information described above with reference to FIG. 10 are output together to the game image to be distributed in any of the layouts (L1) to (L6) illustrated in FIG. 13.

(L1) is a layout in which the display information is arranged in the upper part of the game image and the game title is arranged in the lower part thereof.

(L2) is a layout in which the game title is arranged in the upper part of the game image and the display information is arranged in the lower part thereof.

(L3) is a layout in which the small-size display information is arranged in the upper part of the game image and the game title is arranged in the lower part thereof.

(L4) is a layout in which small-size display information is arranged on the lower left side of the game image and the game title is arranged on the lower right side thereof.

(L5) is a layout in which the game title is arranged on the lower left side of the game image and the small-size display information is arranged on the lower right side thereof.

(L6) is a layout in which only the game title is arranged below the game image.

For example, the distribution user 20 can select one layout from these distribution image layouts as the distribution image layout.

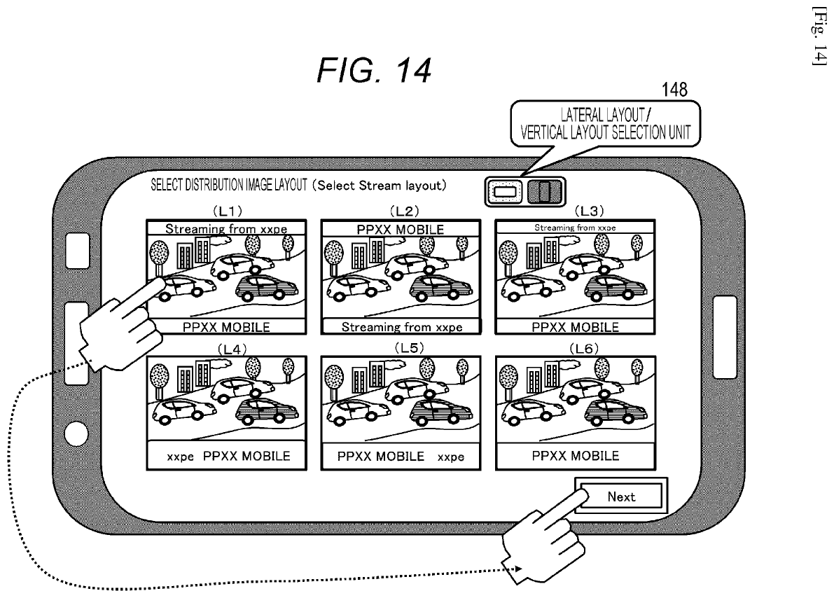

For example, when the distribution user 20 selects the layout (L1) as illustrated in FIG. 14 and operates the operation unit (Next), the distribution image editing screen of the selected layout (L1) is displayed.

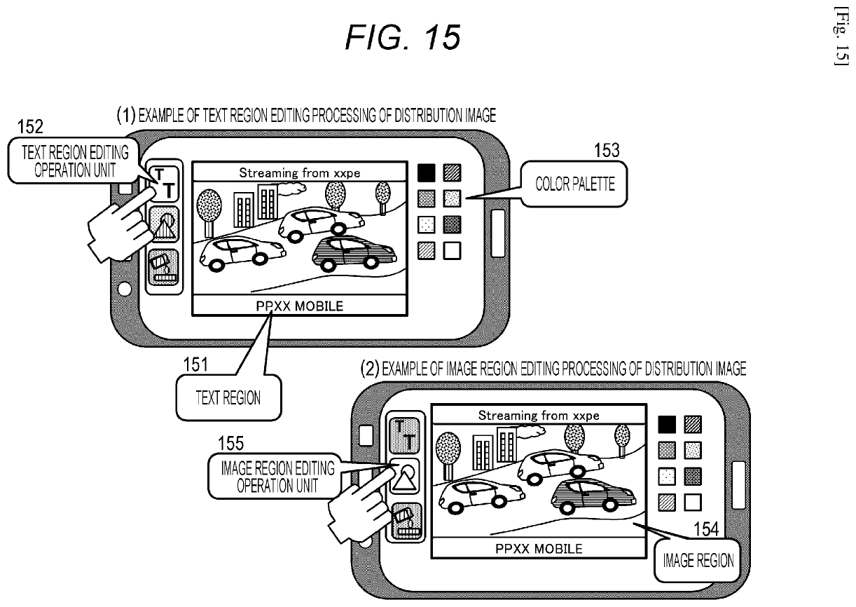

FIG. 15 illustrates an example of the editing screen of the distribution image of the selected layout (L1).

FIG. 15 illustrates the following two diagrams.
(1) Example of text region editing processing of distribution image
(2) Example of image region editing processing of distribution image

The text region of the distribution image is a text region 151 in which a game title and the like are displayed as illustrated in FIG. 15(1).

In a case where the text region 151 is edited, the user operates (taps) a text region editing operation unit 152. By this operation, the text region 151 can be edited.

For example, characters, sizes, colors, positions, and the like to be output to the text region 151 can be set. For example, by selecting a desired color from the color palette 153, it is possible to set and change the color of the text, the color serving as the background of the text, and the like.

Furthermore, the image region of the distribution image is an image region 154 in which a game image is displayed as illustrated in FIG. 15 (2).

In a case where the image region 154 is edited, the user operates (taps) the image region editing operation unit 155. With this operation, the image region 154 can be edited.

For example, the size, position, and the like of the image region 154 can be set.

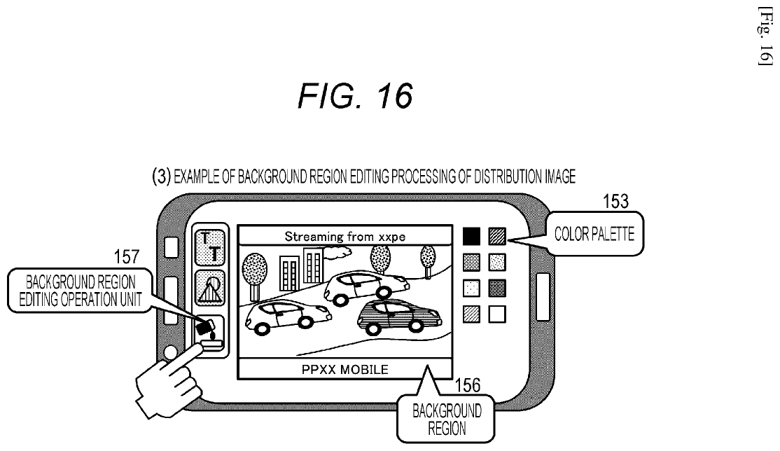

Moreover, as illustrated in FIG. 16, a background region of the distribution image can be edited. As illustrated in FIG. 16, the background region is a region surrounding the image region in which the game image is displayed, for example, a background region 156 including a background portion of a region in which text is displayed.

In a case where the background region 156 is edited, the user operates (taps) a background region editing operation unit 157. By this operation, the background region 156 can be edited.

For example, the color, position, and the like of the background region 156 can be set. For example, a background color and the like can be set and changed by selecting a desired color from the color palette 153.

Note that the example of distribution image editing processing described with reference to FIGS. 13 to 16 is a processing example in which the distribution user 20 holds the information processing apparatus (transmission terminal) 100 laterally (horizontally long), plays a game, and edits the setting of the distribution image at the time of distribution.

In the [(g) distribution image editing/display unit 127] of the preset menu before data distribution (UI) illustrated in FIG. 9, the distribution user 20 can hold the information processing apparatus (transmission terminal) 100 vertically (vertically long), play a game, and edit the setting of the distribution image at the time of distribution.

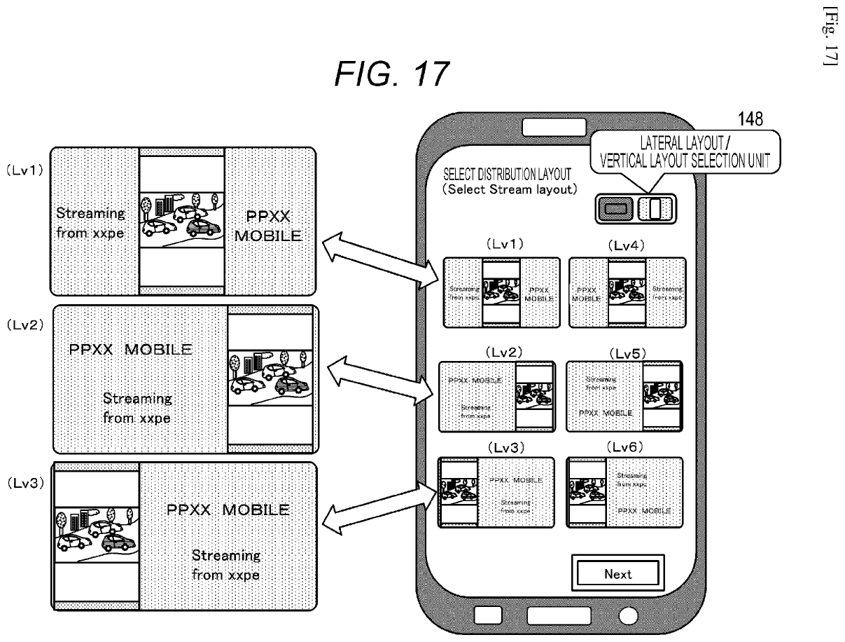

An example of processing of editing a distribution image when the distribution user 20 holds the information processing apparatus (transmission terminal) 100 vertically (vertically long), plays a game, and distributes the game will be described with reference to FIG. 17 and subsequent drawings.

First, layout selection processing of the distribution image is performed. As illustrated in FIG. 17, a plurality of different distribution image layouts is displayed on the display unit of the information processing apparatus (transmission terminal) 100.

In FIG. 17, six types of distribution image layouts (Lv1) to (Lv6) displayed on the information processing apparatus 100 are illustrated on the right side, and enlarged views of the layouts (Lv1) to (Lv3) are illustrated on the left side.

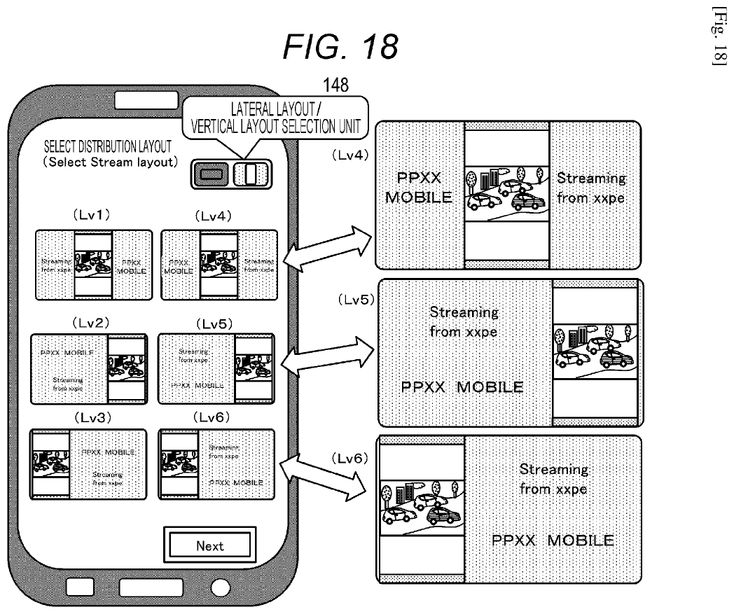

Furthermore, FIG. 18 illustrates six types of distribution image layouts (Lv1) to (Lv6) displayed on the information processing apparatus 100 on the left side, and illustrates enlarged views of the layouts (Lv4) to (Lv6) on the right side.

Note that the example of the distribution image layout illustrated in FIGS. 17 and 18 is a vertical layout, that is, an example of the layout of the distribution image when the distribution user 20 holds the information processing apparatus (transmission terminal) 100 vertically (vertically long), plays a game, and distributes the distribution image, and is displayed in a case where the right vertical layout is selected from the lateral layout/vertical layout selection unit 148 in the upper parts of FIGS. 17 and 18.

It is image data in which the game title described above with reference to FIG. 10 and the display information are output together with the game image to be distributed in any of the layouts (Lv1) to (Lv6).

As described above with reference to FIG. 10, the display information including, for example, the type, name, and the like of the distribution terminal on which the game distribution is being executed can be used as the display information. However, the distribution user 20 can freely set the display information.

The layouts (Lv1) to (Lv6) illustrated in FIGS. 17 and 18 are the following layouts.

(Lv1) is a layout in which the display information is arranged on the left side of the game image and the game title is arranged on the right side thereof.

(Lv2) is a layout in which the game title and the display information are arranged on the left side of the game image.

(Lv3) is a layout in which the game title and the display information are arranged on the right side of the game image.

(Lv4) is a layout in which the game title is arranged on the left side of the game image and the display information is arranged on the right side thereof.

(Lv5) is a layout in which the game title and the display information are arranged on the left side of the game image.

(Lv6) is a layout in which the game title and the display information are arranged on the right side of the game image.

For example, the distribution user 20 can select one layout from these distribution image layouts as the distribution image layout.

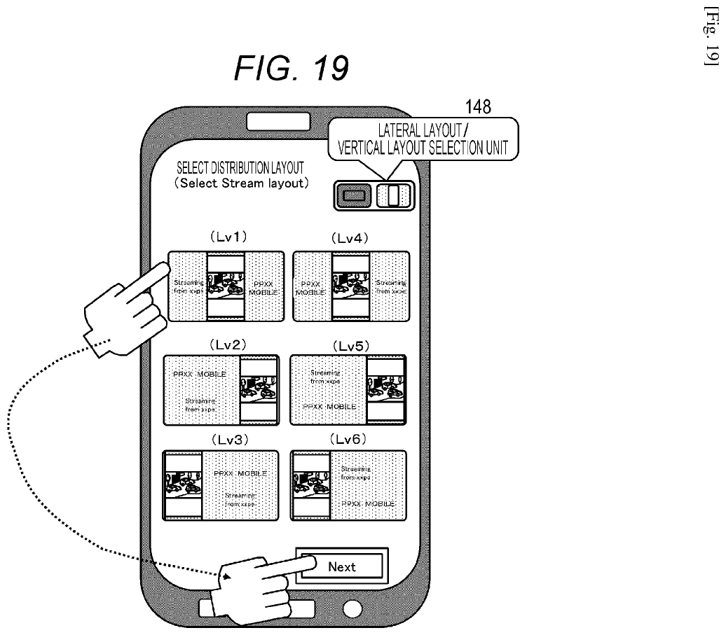

For example, when the distribution user 20 selects the layout (Lv1) as illustrated in FIG. 19 and operates the operation unit (Next), the distribution image editing screen of the selected layout (Lv1) is displayed.

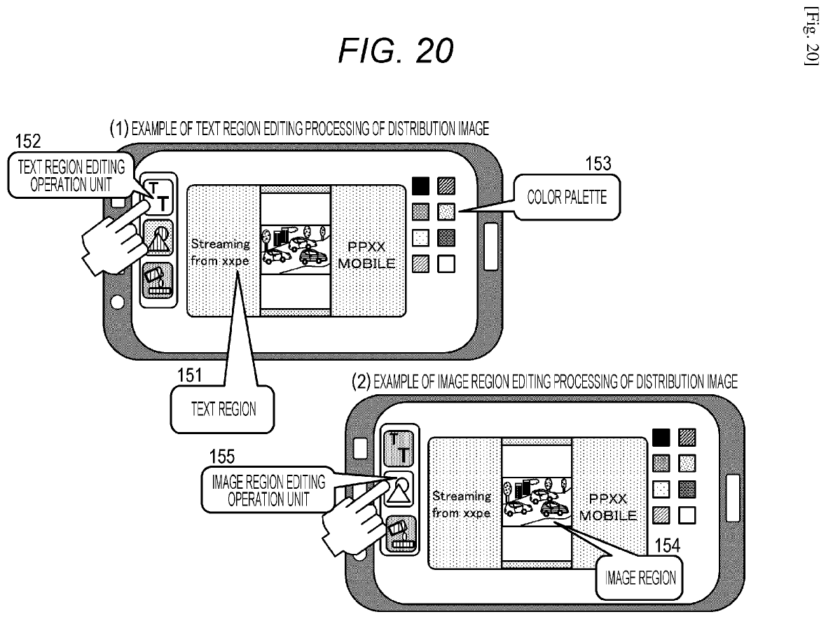

FIG. 20 illustrates an example of the distribution image editing screen of the selected layout (Lv1).

FIG. 20 illustrates the following two diagrams.
(1) Example of text region editing processing of distribution image
(2) Example of image region editing processing of distribution image

The text region of the distribution image is the text region 151 in which a game title and the like are displayed as illustrated in FIG. 20(1).

In a case where the text region 151 is edited, the user operates (taps) a text region editing operation unit 152. By this operation, the text region 151 can be edited. For example, characters, sizes, colors, positions, and the like to be output to the text region 151 can be set. For example, by selecting a desired color from the color palette 153, it is possible to set and change the color of the text, the color serving as the background of the text, and the like.

Furthermore, the image region of the distribution image is the image region 154 in which the game image is displayed as illustrated in FIG. 20 (2).

In a case where the image region 154 is edited, the user operates (taps) the image region editing operation unit 155. With this operation, the image region 154 can be edited.

For example, the size, position, and the like of the image region 154 can be set.

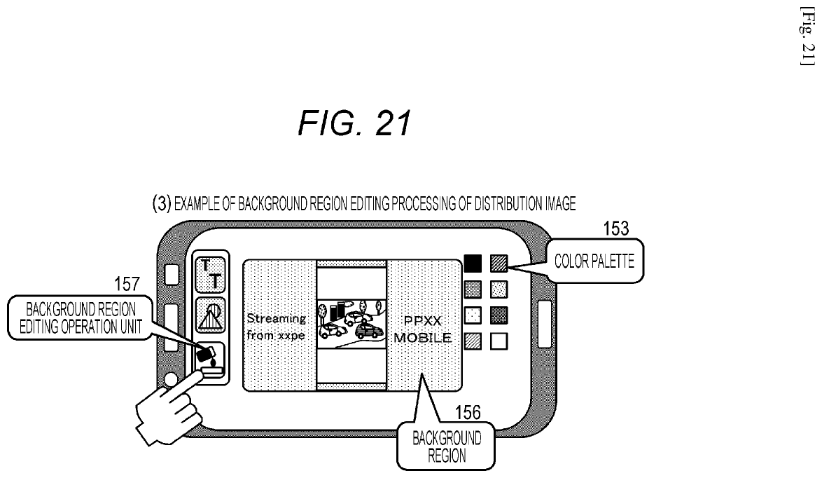

Moreover, as illustrated in FIG. 21, the background region of the distribution image can be edited. As illustrated in FIG. 21, the background region is a region surrounding the image region in which the game image is displayed, for example, the background region 156 including a background portion of a region in which text is displayed.

In a case where the background region 156 is edited, the user operates (taps) a background region editing operation unit 157. By this operation, the background region 156 can be edited.

For example, the color, position, and the like of the background region 156 can be set. For example, a background color and the like can be set and changed by selecting a desired color from the color palette 153.

Note that the text region 151 and the background region 156 described with reference to FIGS. 20 and 21 may be set to display not only text information but also a still image and a moving image. For example, a still image or a moving image for explaining the content of a game and the like may be displayed. Furthermore, a plurality of still images explaining a game may be configured to be sequentially switched and displayed in the background region 156. In this case, for example, various settings can be made, such as setting to switch to the next still image when the user taps the background region 156, or a configuration to switch to the next still image after a predetermined time elapses.

As described above, the information processing apparatus (transmission terminal) 100 of the present disclosure can individually execute, for the distribution image, two types of processing such as the lateral layout selection and editing processing, and the vertical layout selection and editing processing.

Through the processing, in a case where the distribution user 20 changes the orientation of the information processing apparatus (transmission terminal) 100 during the execution of the game distribution, it is possible to automatically switch and distribute the layout of the distribution data to the distribution image corresponding to the preset lateral layout or the distribution image corresponding to the vertical layout.

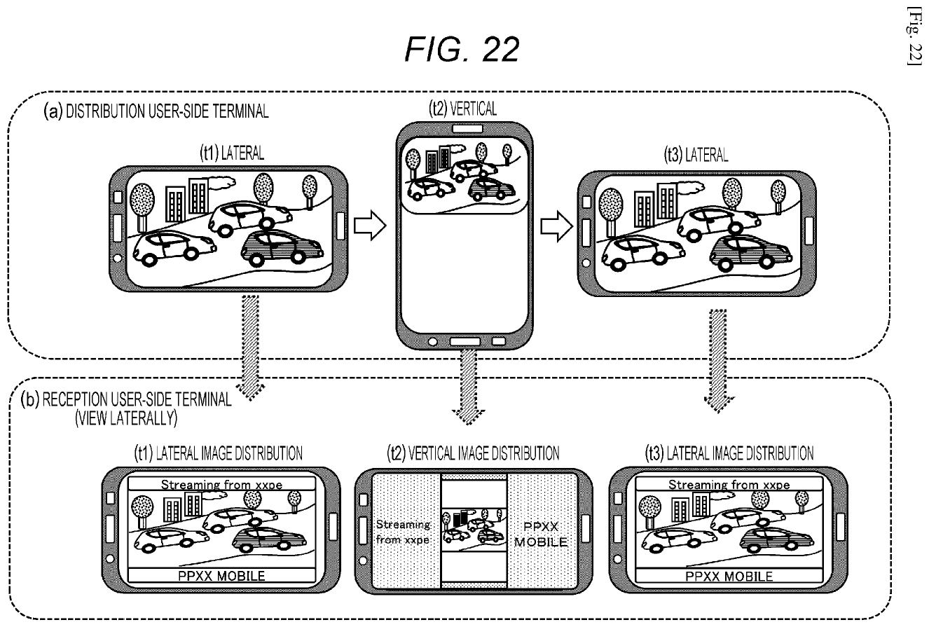

A specific example of the switching processing will be described with reference to FIG. 22.

FIG. 22 illustrates the following drawings.
(a) Distribution user-side terminal
(b) Reception user-side terminal

Both drawings illustrate the transition of the display image in each user terminal with the time transition (t1 to t3).

As illustrated in the temporal transition data of the distribution user-side terminal in FIG. 22(a), the distribution-side user executes and distributes the game while turning the information processing apparatus (transmission terminal) 100 laterally at the time (t1), but executes and distributes the game while holding the information processing apparatus (transmission terminal) 100 vertically at the time (t2), and thereafter, executes and distributes the game while turning the information processing apparatus (transmission terminal) 100 laterally again at the time (t3).

Meanwhile, as illustrated in the temporal transition data of the reception user-side terminal in FIG. 22(b), the reception-side user continuously receives and views the game while turning the information processing apparatus (reception terminal) 200 laterally for the times (t1) to (t3).

In such a case, in the time (t1) and the time (t3) during which the distribution-side user executes and distributes the game while turning the information processing apparatus (transmission terminal) 100 laterally, the image set by the setting processing of the lateral distribution image layout described with reference to FIGS. 13 to 16 is distributed and displayed on the reception user-side terminal.

Meanwhile, in the time (t2) during which the distribution-side user executes and distributes the game while turning the information processing apparatus (transmission terminal) 100 vertically, the image set by the setting processing of the vertical distribution image layout described with reference to FIGS. 17 to 21 is distributed and displayed on the reception user-side terminal.

As described above, in a case where the information processing apparatus (transmission terminal) 100 is oriented horizontally or vertically, the distribution-side user can distribute the image of the layout set by the user in each case.

Returning to FIG. 9, the description of each component of the preset menu before data distribution (UI) will be continued.

The “(h) privacy setting screen editing/display unit 128” is a processing unit that, when the distribution user 20 who executes and distributes a game using the information processing apparatus (transmission terminal) 100 displays privacy data other than the game screen on the display unit of the information processing apparatus (transmission terminal) 100, edits a “privacy setting screen” which is alternative distribution image data to be distributed and displayed on the information processing apparatus (reception terminal) of the viewing user 30 instead of the displayed privacy data.

For example, there is a case where the distribution user 20 performs credit card number input processing using the information processing apparatus (transmission terminal) 100 during execution and distribution of a game. Alternatively, there is a case where the camera is activated and a camera-imaged image is displayed.

These pieces of data are privacy data and are data that are not desired to be distributed.

As described above, in a case where data other than the game execution screen is displayed on the display unit of the information processing apparatus (transmission terminal) 100, the data processing unit of the information processing apparatus (transmission terminal) 100 switches the distribution data to a preset “privacy setting screen” and distributes the distribution data.

The “(h) privacy setting screen editing/display unit 128” edits and displays the “privacy setting screen”.

For example, screen data illustrated in a region of the “(h) privacy setting screen editing/display unit 128” illustrated in FIG. 9 is an example of the “privacy setting screen”.

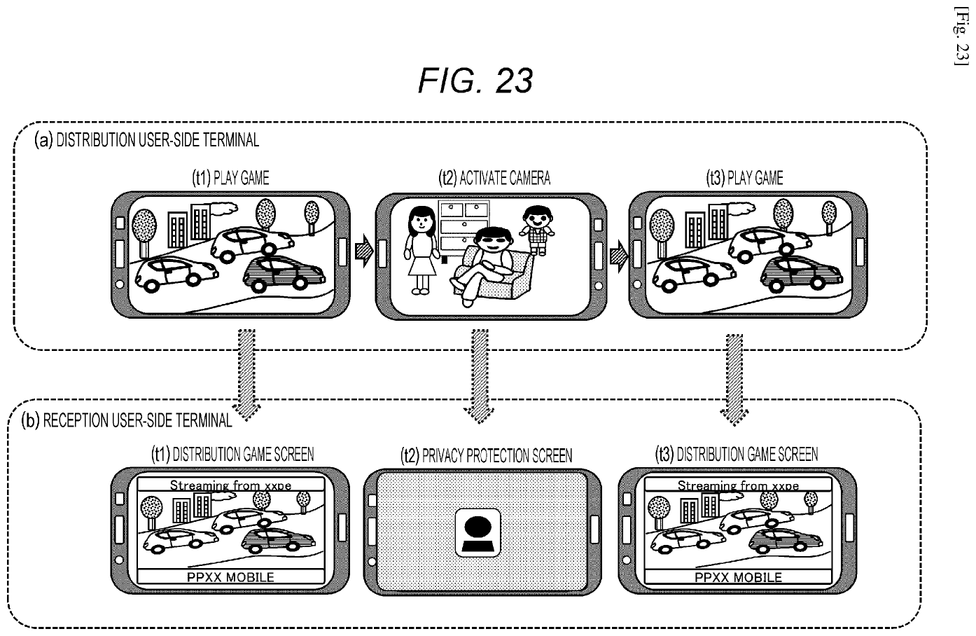

A usage example of the “privacy setting screen” will be described with reference to FIG. 23.

FIG. 23 illustrates the following drawings.
(a) Distribution user-side terminal
(b) Reception user-side terminal

Both drawings illustrate the transition of the display image in each user terminal with the time transition (t1 to t3).

As illustrated in the temporal transition data of the distribution user-side terminal in FIG. 23 (a), the distribution-side user executes and distributes the game using the information processing apparatus (transmission terminal) 100 at the time (t1), and an image imaged by a camera function of the information processing apparatus (transmission terminal) 100 is displayed at the time (t2). Thereafter, at the time (t3), the game is executed and distributed again using the information processing apparatus (transmission terminal) 100.

As illustrated in the temporal transition data of the reception user-side terminal in FIG. 23 (b), the reception-side user receives and displays the game screen distributed from the information processing apparatus (transmission terminal) 100 at the time (t1).

At the time (t2), the “privacy setting screen” distributed from the information processing apparatus (transmission terminal) 100 is received and displayed. Thereafter, at the time (t3), the game screen distributed from the information processing apparatus (transmission terminal) 100 is received and displayed.

As described above, in a case where data other than the game screen, such as a camera-imaged image, is displayed on the display unit of the distribution user-side terminal, the data processing unit of the information processing apparatus (transmission terminal) 100 switches the distribution data to a preset “privacy setting screen” and distributes the distribution data.

With this processing, it is possible to prevent a situation in which various privacy data such as a camera-imaged image, a credit card number, and a personal identification number are erroneously distributed and leaked.

Returning to FIG. 9, the description of each component of the preset menu before data distribution (UI) will be continued.

The “(i) microphone setting unit 129” and the “(j) volume setting unit 130” are processing units that adjust audio data transmitted or output from the information processing apparatus (transmission terminal) 100 that is a distribution user-side terminal.

The audio adjustment menu (UI) is displayed by operating (tapping) the “(i) microphone setting unit 129” or the “(j) volume setting unit 130”.

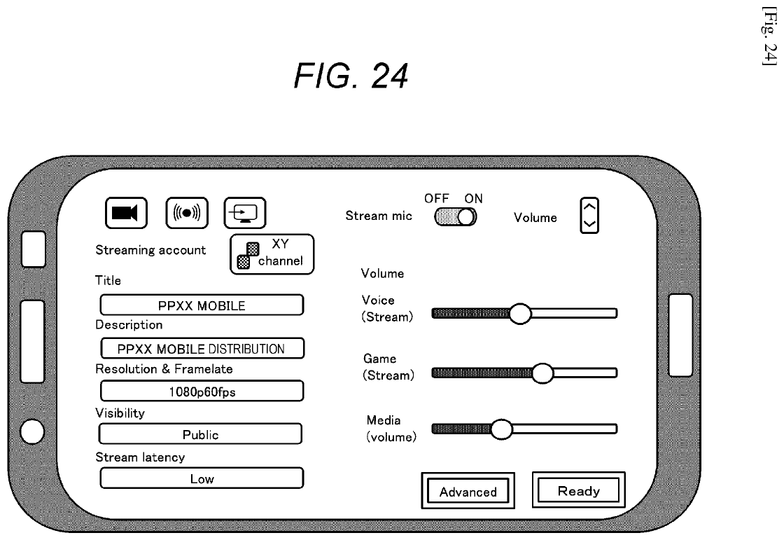

A specific example is illustrated in FIG. 24.

When the user operates (taps) the “(i) microphone setting unit 129” or the “(j) volume setting unit 130”, the audio adjustment menu (UI) as illustrated in FIG. 24 is displayed.

The audio adjustment menu (UI) illustrated in FIG. 24 includes an operation unit for adjusting each volume of voice of the distribution user 20 (voice (stream)), game sound being executed (Game (stream)), and output sound of media (Media (volume)), and the user can adjust the volume of each sound by operating the operation unit.

Returning to FIG. 9, the description of each component of the preset menu before data distribution (UI) will be continued.

The “(k) extended function setting UI transition unit 131” is an operation unit for displaying an extended function setting UI in a case where setting and adjustment are performed for an extended function other than the items illustrated in FIG. 9.

For example, examples of the function of setting and adjusting using the extended function setting UI includes functions such as power supply setting, display/non-display setting of a notification message or the like, and ON/OFF of automatic luminance adjustment, and detailed settings of privacy display screen, and it is possible to display a UI for setting and adjusting the extended function described above and the like by operating (tapping) the “(k) extended function setting UI transition unit 131”.

### (4. Details of Configuration of Setting Menu During Data Distribution (UT) and Distribution Data Setting Processing Using Setting Menu During Data Distribution (UI))

Next, the configuration of the setting menu during data distribution (UI) and details of the distribution data setting processing using the setting menu during data distribution (UI) will be described.

As described above with reference to FIG. 8, when the distribution user 20 executes the processing of displaying the setting menu during data distribution (UI) during the execution and distribution of the game in (Step S10) illustrated in FIG. 8, the setting menu during data distribution (UI) (user interface) 103 as illustrated in (Step S11) of FIG. 8 is displayed.

The setting menu during data distribution (UI) 103 is a UI for the distribution user 20 to perform various settings related to the distribution data such as setting of the game image to be distributed during execution and distribution of the game.

Hereinafter, a detailed configuration of the setting menu during data distribution (UI) 103 and details of the distribution data setting processing using the setting menu during data distribution (UI) 103 will be described.

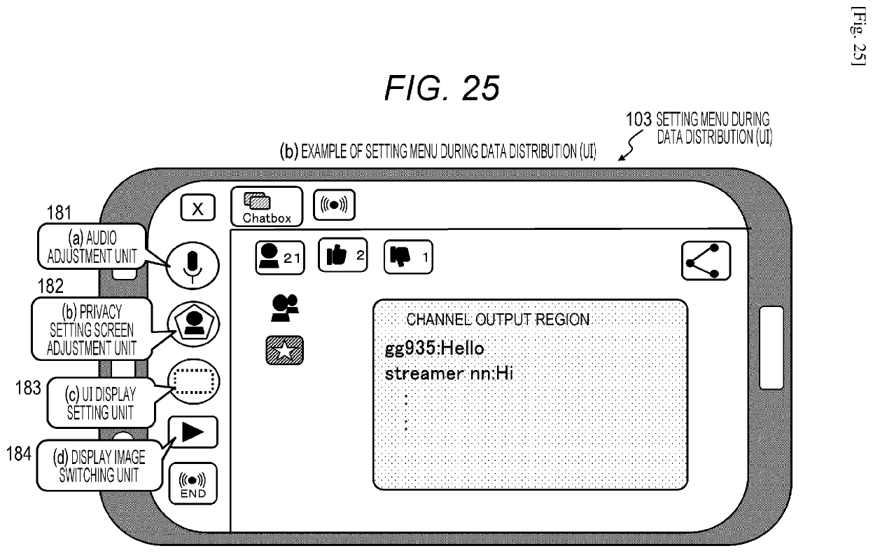

FIG. 25 illustrates an example of the setting menu during data distribution (UI) 103 displayed on the information processing apparatus (transmission terminal) 100 used by the distribution user 20.

As illustrated in FIG. 25, the following processing units that can be operated by the user are displayed in the setting menu during data distribution (UI) 103.
(a) Audio adjustment unit 181
(b) Privacy setting screen adjustment unit 182
(c) UI display setting unit 183
(d) Display image switching unit 184

The “(a) audio adjustment unit 181” is a processing unit that adjusts audio data to be distributed or output during game distribution by the distribution user 20.

By operating (tapping) the “(a) audio adjustment unit 181”, the audio adjustment menu (UI) is displayed.

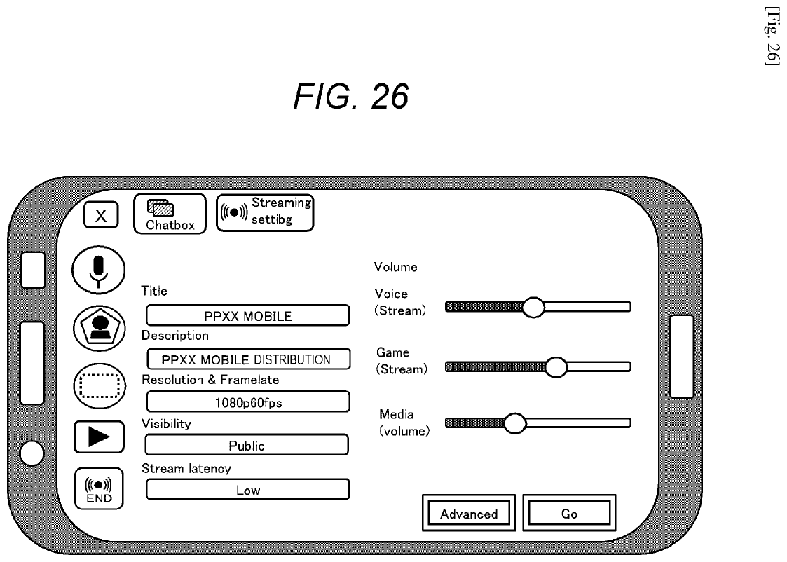

A specific example is illustrated in FIG. 26.

The UI illustrated in FIG. 26 has substantially similar configuration as the preset UI described above with reference to FIG. 24.

The audio adjustment menu (UI) illustrated in FIG. 26 includes an operation unit for adjusting each volume of voice of the distribution user 20 (voice (stream)), game sound being executed (Game (stream)), and output sound of media (Media (volume)), and the user can adjust the volume of each sound by operating the operation unit.

The “(b) privacy setting screen adjustment unit 182” is an operation unit for setting and adjusting the “privacy setting screen” described above with reference to FIG. 23.

A user interface (privacy setting screen adjustment UI) for setting and adjusting the “privacy setting screen” is displayed by operating (tapping) the “(b) privacy setting screen adjustment unit 182”.

The user can perform, for example, the following processing using the privacy setting screen adjustment UI.

### Switching Between Use and Non-Use of “Privacy Setting Screen”

Switching between automatic execution and manual execution of distribution processing of “privacy setting screen”

The “(c) UI display setting unit 183” is an operation unit for switching whether to display the UI or hide the UI during the execution of the game.

The “(d) display image switching unit 184” is an operation unit for performing switching processing on whether an image to be displayed on the display unit of the information processing apparatus (transmission terminal) 100 while the distribution user 20 is executing or distributing the game is a game image being executed by the information processing apparatus (transmission terminal) 100 or a monitoring image (viewing image) being viewed by the viewing user 30 on the information processing apparatus (reception terminal) 200.

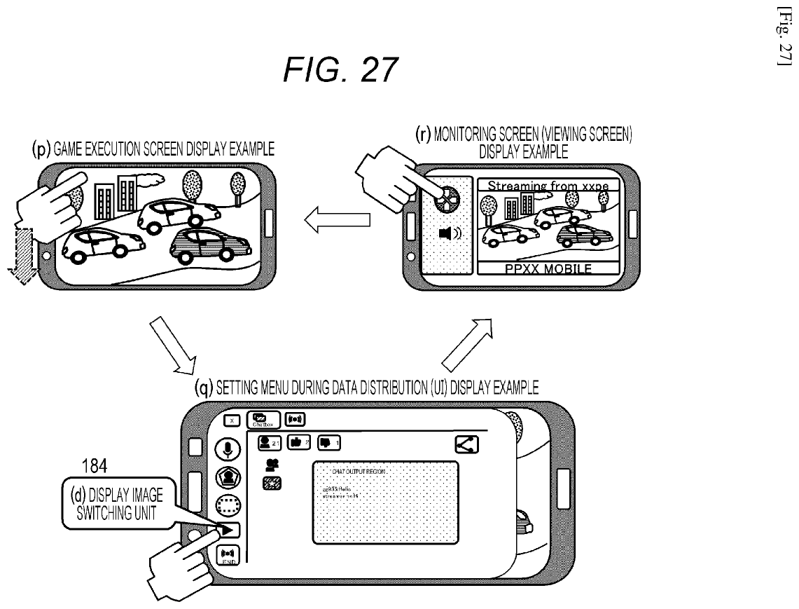

A specific example of the display image switching processing using the “(d) display image switching unit 184” will be described with reference to FIG. 27.

FIG. 27 illustrates the following drawings.
(p) Game execution screen display example
(q) Setting menu during data distribution (UI) display example
(r) Monitoring screen (viewing screen) display example

The “(p) game execution screen display example” is an example in which the distribution user 20 displays the game screen being executed by the distribution user 20 on the display unit of the information processing apparatus (transmission terminal) 100 while the distribution user is executing and distributing the game.

The “(q) setting menu during data distribution (UI) display example” is an example in which the distribution user 20 displays the setting menu during data distribution (UI) by performing an operation (for example, flick processing of sliding a finger) for displaying the setting menu during data distribution (UI) on the game execution screen illustrated as the “(p) game execution screen display example”.

When the distribution user 20 operates (taps) the “(d) display image switching unit 184” displayed on the setting menu during data distribution (UI), the monitoring screen (viewing screen) is displayed on the display unit of the information processing apparatus (transmission terminal) 100.

The “(r) monitoring screen (viewing screen) display example” corresponds to a game screen that the viewing user 30 is viewing on the information processing apparatus (reception terminal) 200.

Note that the monitoring screen (viewing screen) is an image slightly delayed from the game execution screen (p) due to a communication delay and the like.

The information processing apparatus (transmission terminal) 100 of the distribution user 20 reacquires the transmission data of the information processing apparatus (transmission terminal) 100, that is, the distribution data of the distribution image and the like from the management server 50 illustrated in FIG. 2, for example, and outputs the reacquired transmission data to the display unit of the information processing apparatus (transmission terminal) 100.

The distribution user 20 operates (taps) the icon on the left side illustrated in the [(r) monitoring screen (viewing screen) display example] of FIG. 27, so that the display screen of the “(p) game execution screen display example” illustrated in FIG. 27, that is, the game screen being executed by the distribution user 20 can be returned and displayed.

Note that, as described above, the monitoring screen (viewing screen) is an image slightly delayed from the (p) game execution screen due to a communication delay and the like, and the game voice is also delayed.

Therefore, when the distribution user 20 outputs a voice corresponding to the running game screen while the monitoring screen (viewing screen) is displayed, a gap occurs between the image and the voice, and the user feels uncomfortable.

In order to prevent such a situation, the information processing apparatus (transmission terminal) 100 of the distribution user 20 executes the output sound switching processing of outputting a voice corresponding to the display data also for the output sound from the speaker of the information processing apparatus (transmission terminal) 100.

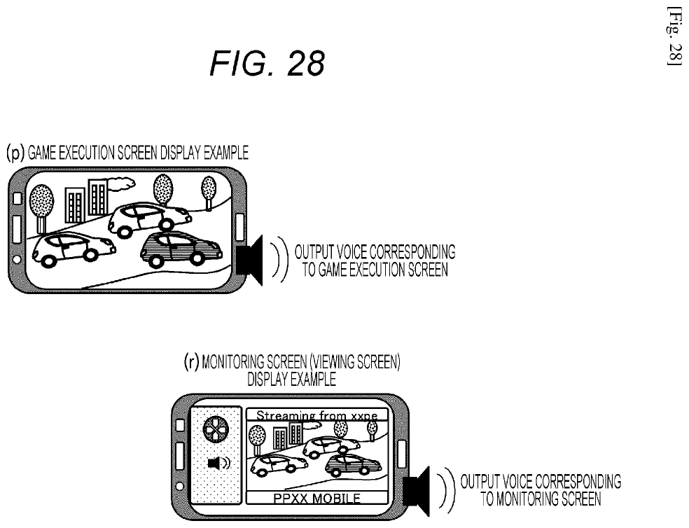

That is, the audio switching processing as illustrated in FIG. 28 is executed.

While the game execution screen corresponding to the (p) game execution screen display example is displayed, a voice corresponding to the game execution screen is output from the speaker of the information processing apparatus (transmission terminal) 100.

Meanwhile, while the monitoring screen corresponding to the (r) display example of the monitoring screen (viewing screen) is displayed, a voice corresponding to the monitoring screen is output from the speaker of the information processing apparatus (transmission terminal) 100.

### (5. Other Functions of Information Processing Apparatus of Present Disclosure)

Next, other functions of the information processing apparatus of the present disclosure will be described.

Hereinafter, the following functions of the information processing apparatus (transmission terminal) 100 used by the distribution user 20 will be sequentially described.
(1) UI display function for screen other than game execution screen
(2) Function of generating own device output image and distribution image as images of different modes.
(3) Processing function in case where information processing apparatus (transmission terminal) 100 has two-screen configuration
   (5-1.(1) UI Display Function for Screen Other than Game Execution Screen

First, a UI display function for a screen other than the game execution screen will be described.

As described above, the information processing apparatus (transmission terminal) 100 used by the distribution user 20 outputs various menus (UI) such as the main menu (UI) described with reference to FIG. 4, the preset menu before data distribution (UI) 102 described with reference to FIGS. 5 and 9 to 24, the setting menu during data distribution (UI) 103, and the like described with reference to FIGS. 8 and 25 to 28.

These menus (UI) are basically displayed and available after the game application is activated.

However, there is a case where the distribution user 20 desires to perform setting processing, change processing, and the like such as game setting and distribution setting even in a period in which the game is not executed.

For example, there is a case where it is desired to perform setting processing, change processing, and the like of setting of a game, distribution setting, and the like while activating a chat application and chatting with a game friend or executing live streaming processing, and the like.

Even in such a case, the information processing apparatus (transmission terminal) 100 of the present disclosure enables the distribution user 20 to display and operate the UI.

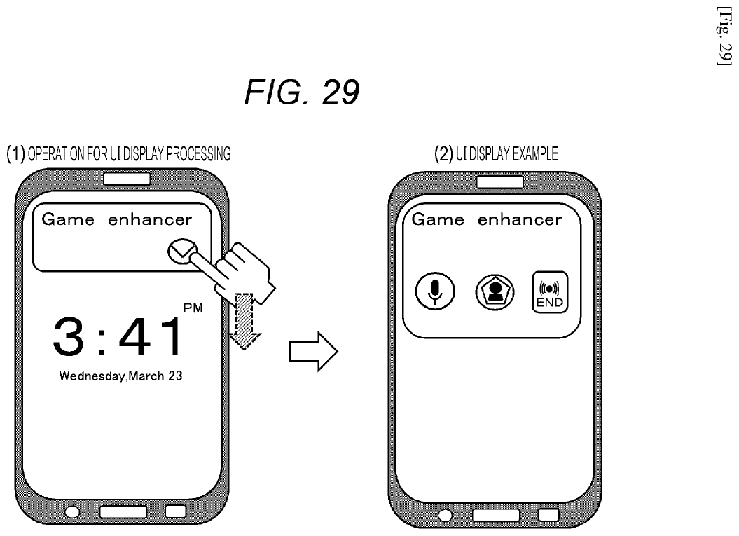

FIG. 29 illustrates a specific menu (UI) display processing example.

FIG. 29 (1) illustrates a menu (UI) display processing example.

For example, as illustrated in FIG. 29 (1), the distribution user 20 performs the flick processing of sliding a finger from the upper part toward the lower part of the screen of the information processing apparatus 100 while activating a chat application and chatting with a game friend or performing a live streaming processing.

With this processing, the menu (UI) as illustrated in the UI display example of FIG. 29 (2) is displayed. Various game settings, distribution settings, and the like can be performed by operating (tapping) an icon displayed on a menu (UI).

### (5-2.(2) Function of Generating Own Device Output Image and Distribution Image as Images of Different Modes).

Next, the “(2) function of generating the own device output image and the distribution image as images of different modes” which is the function of the information processing apparatus (transmission terminal) 100 used by the distribution user 20 will be described.

The information processing apparatus (transmission terminal) 100 of the present disclosure can generate, output, and distribute the own device output image, that is, two types of images having different specifications of an image to be output to the display unit of the information processing apparatus (transmission terminal) 100 and an image to be externally distributed.

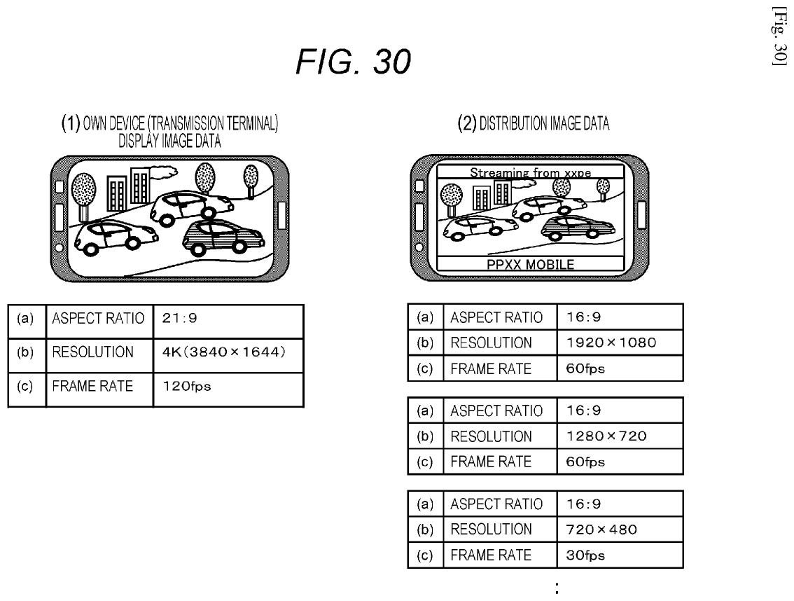

A specific processing example will be described with reference to FIG. 30. FIG. 30 illustrates an example of setting two pieces of image data of (1) own device (transmission terminal) display image data and (2) distribution image data.

For example, the “(1) own device (transmission terminal) display image data” is an image having specifications of (a) Aspect ratio=21:9, (b) Resolution=4K (3840×1644 pixels), and (c) Frame rate=120 bps.

Meanwhile, for example, the “(2) distribution image data” is an image having specifications of (a) Aspect ratio=16:9, (b) Resolution=1920×1080 pixels, and (c) Frame rate=60 bps.

Note that various other settings can be made for the “(2) distribution image data”.

As shown in the drawing, an image having specifications of (a) Aspect ratio=16:9, (b) Resolution=1920×1080 pixels, and (c) Frame rate=60 bps can be set.

An image having specifications of (a) Aspect ratio=16:9, (b) Resolution=1920×1080 pixels, and (c) Frame rate=60 bps can be set.

Note that the setting of the distribution image can be set by the operation of the “(c) resolution/frame rate setting unit” of the preset menu before data distribution (UI) 102 described above with reference to FIG. 9, and can be, for example, images of various specifications (aspect ratio, resolution, frame rate) described above with reference to FIG. 11.

As described above, the information processing apparatus (transmission terminal) 100 of the present disclosure can generate, output, and distribute the own device output image, that is, two types of images having different specifications such as the image to be output to the display unit of the information processing apparatus (transmission terminal) 100 and the image to be externally distributed.

(5-3.(3) Processing Function in Case where Information Processing Apparatus (Transmission Terminal) 100 has Two-Screen Configuration)

Next, a processing function in a case where the information processing apparatus (transmission terminal) 100 has a two-screen configuration will be described.

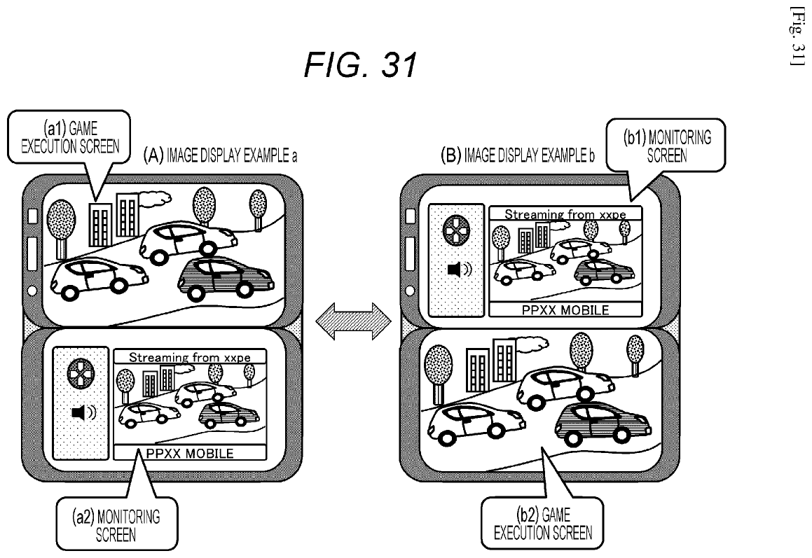

FIG. 31 illustrates a configuration example of the information processing apparatus (transmission terminal) 100 having the two-screen configuration. For example, the smartphone is a foldable smart phone, and has individual display units at two positions of an upper portion and a lower portion.

By configuring the information processing apparatus (transmission terminal) 100 used by the distribution user 20 as a smartphone having such a two-screen configuration, for example, display processing as illustrated in FIG. 31 can be performed.

FIG. 31 illustrates the following two image display examples, that is, illustrates two image display examples of (A) image display example a and (B) image display example b.

In the “(A) Image display example a”, “(a1) game execution screen” is displayed on the upper display unit, and “(a2) monitoring screen” is displayed on the lower display unit.

Meanwhile, in the “(B) Image display example b”, “(b1) monitoring screen” is displayed on the upper display unit, and “(b2) Game execution screen” is displayed on the lower display unit.

The game execution screen and the monitoring screen are screens similar to the screens described above with reference to FIG. 27. That is, the game execution screen is a game screen being executed by the distribution user 20.

The monitoring screen corresponds to the game screen that the viewing user 30 is viewing on the information processing apparatus (reception terminal) 200.

The monitoring screen is displayed by reacquiring the distribution data transmitted from the information processing apparatus (transmission terminal) 100 from the management server 50 illustrated in FIG. 2, for example.

As illustrated in FIG. 31, the distribution user 20 including the information processing apparatus (transmission terminal) 100 having the two-screen configuration as illustrated in FIG. 31 can freely switch between the “(A) image display example a” in which the “(a1) game execution screen” is displayed on the upper display unit and the “(a2) monitoring screen” is displayed on the lower display unit, and the “(B) image display example b” in which the “(b1) monitoring screen” is displayed on the upper display unit and the “(b2) game execution screen” is displayed on the lower display unit.

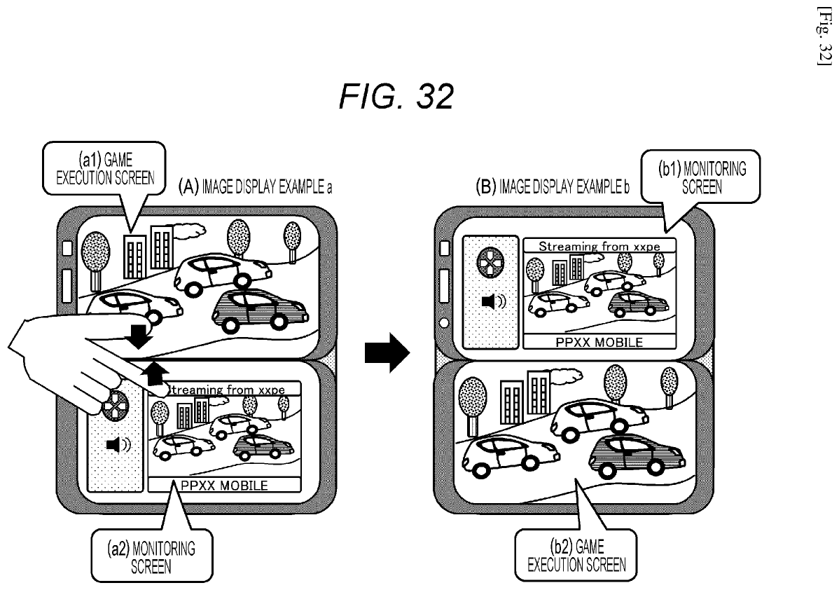

Note that, as illustrated in FIG. 32, for example, the switching processing between the “(A) image display example a” and the “(B) image display example b” can be executed by performing pinch processing (processing of touching and pinching or expanding upper and lower screens with two fingers) by the user, swipe processing (processing of touching the screen with a finger and sliding the screen) by the user, or the like.

Note that, as described above, the monitoring screen (viewing screen) is an image slightly delayed from the game execution screen due to a communication delay and the like, and the game voice is also delayed.

Therefore, when the distribution user 20 outputs a voice corresponding to the running game screen while the monitoring screen (viewing screen) is displayed, a gap occurs between the image and the voice, and the user feels uncomfortable.

In order to prevent such a situation, the distribution user 20 can switch the output sound from the speaker.

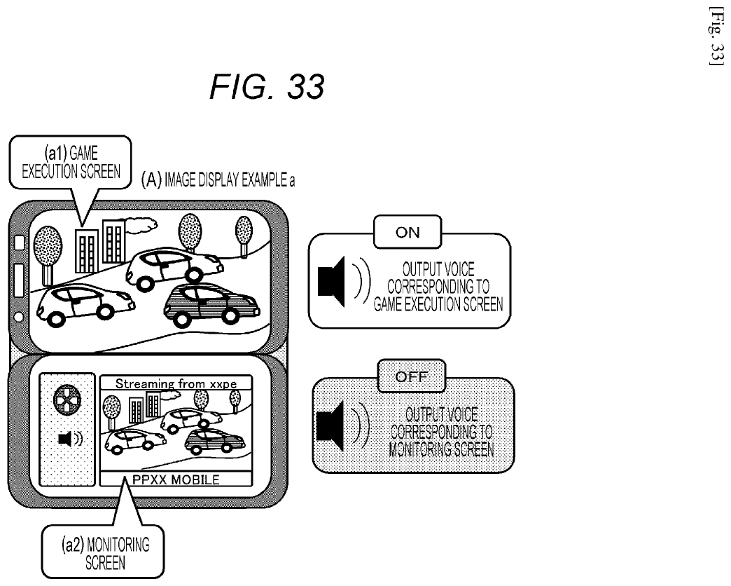

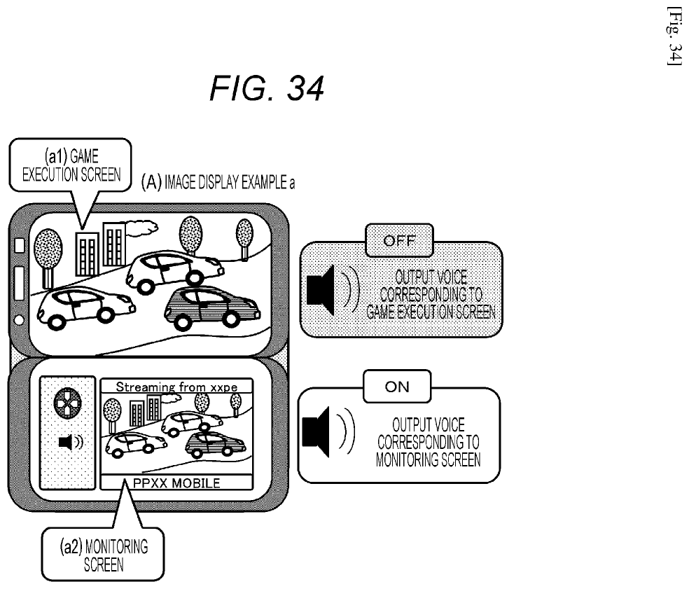

That is, the audio switching processing as illustrated in FIGS. 33 and 34 is executed.

FIG. 33 illustrates a setting in which the voice corresponding to the game execution screen is output from the speaker of the information processing apparatus (transmission terminal) 100 and the voice output corresponding to the monitoring screen is stopped.

Meanwhile, FIG. 34 illustrates a setting in which the voice corresponding to the monitoring screen is output from the speaker of the information processing apparatus (transmission terminal) 100 and the voice output corresponding to the game execution screen is stopped.

Note that the speaker output switching control of the information processing apparatus (transmission terminal) 100 is executed, for example, in the following manner.

For example, the information processing apparatus (transmission terminal) 100 detects a user's operation (tap) on each screen or an operation (tap) on a speaker icon (not illustrated) individually displayed on each screen, and executes output sound switching processing of the speaker according to the detection information.

Alternatively, for example, sound corresponding to an image output to one of the two screens, for example, the lower screen, may be output from the speaker.

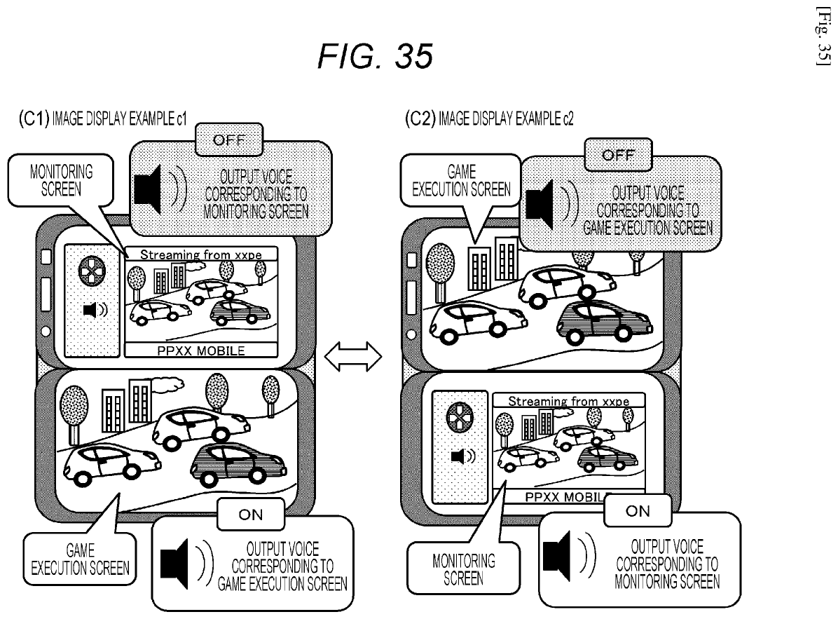

For example, as illustrated in FIG. 35, sound corresponding to an image displayed on a lower screen of the information processing apparatus (transmission terminal) 100 having a two-screen configuration is output.

(C1) An image display example c1 of FIG. 35 outputs the game execution sound because the image displayed on the lower screen of the information processing apparatus (transmission terminal) 100 having the two-screen configuration is the game execution screen.

Meanwhile, (C2) an image display example c2 in FIG. 35 outputs the monitoring screen corresponding sound indicating that the image displayed on the lower screen of the information processing apparatus (transmission terminal) 100 having the two-screen configuration is the monitoring screen.

Moreover, a setting opposite to the setting illustrated in FIG. 35 may be a setting in which sound corresponding to the image output to the upper screen is output from the speaker.

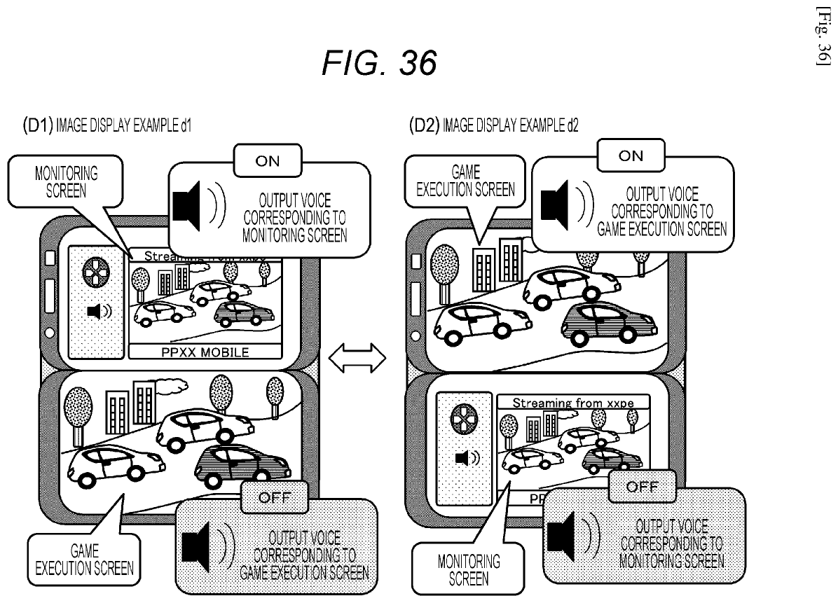

For example, as illustrated in FIG. 36, sound corresponding to an image displayed on an upper screen of the information processing apparatus (transmission terminal) 100 having a two-screen configuration is output.

In (D1) an image display example d1 of FIG. 36, since the image displayed on the upper screen of the information processing apparatus (transmission terminal) 100 having the two-screen configuration is the monitoring screen, the monitoring screen corresponding sound is output.

Meanwhile, in (D2) an image display example d2 of FIG. 36, since the image displayed on the upper screen of the information processing apparatus (transmission terminal) 100 having the two-screen configuration is the game execution screen, the game execution sound is output.

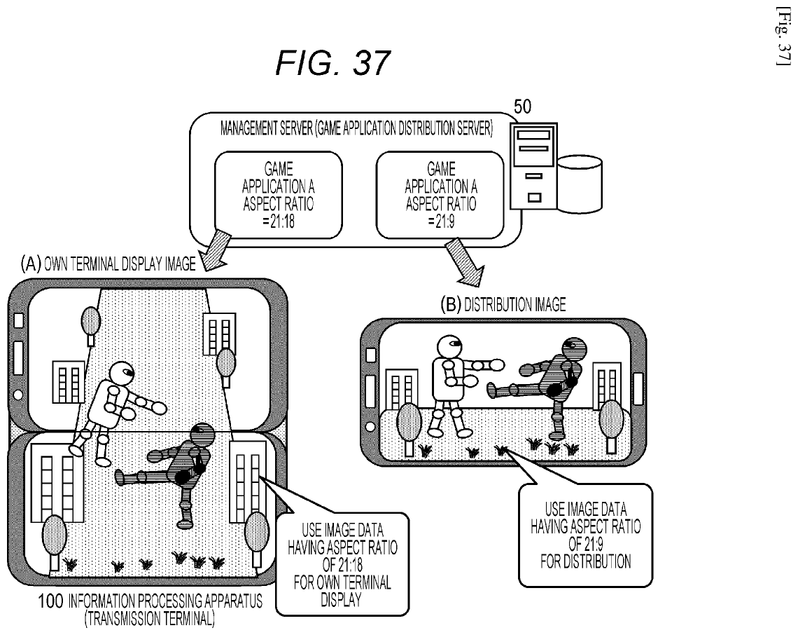

Moreover, another usage example of the information processing apparatus (transmission terminal) 100 having the two-screen configuration will be described with reference to FIG. 37.

“(A) an own terminal display image” in FIG. 37 illustrates an example in which the game execution screen of one game application is displayed using the display region of all of the two screens of the information processing apparatus (transmission terminal) 100 having the two-screen configuration.

This game application is, for example, an application provided by the management server (game application distribution server) 50, and is a game application including an image with an aspect ratio of 21:18.

The information processing apparatus (transmission terminal) 100 receives a game application including an image with an aspect ratio of 21:18 from the management server (game application distribution server) 50, and executes a game by displaying the game application in the display region of all of the two screens of the information processing apparatus (transmission terminal) 100.

Moreover, the information processing apparatus (transmission terminal) 100 also receives, as a game application image for live distribution, a game application for one-screen smartphone display of aspect ratio=21:9 and the like, for example.

The information processing apparatus (transmission terminal) 100 receives these two pieces of application image data, one of which is used for displaying the own terminal and the other is used for live distribution.

Note that the image specification (Aspect ratio, resolution, frame rate) of the live distribution image can be selected from, for example, various specifications described above with reference to FIG. 11.

However, in the processing described with reference to FIG. 37, the information processing apparatus (transmission terminal) 100 needs to receive application image data of two different aspect ratios from the management server (game application distribution server) 50.

As described above, without receiving application image data of two different aspect ratios, only one game application configured by an image of aspect ratio=21:18 corresponding to 2 screens may be received from the management server (game application distribution server) 50, and processing of generating and distributing distribution images of different aspect ratios may be performed.

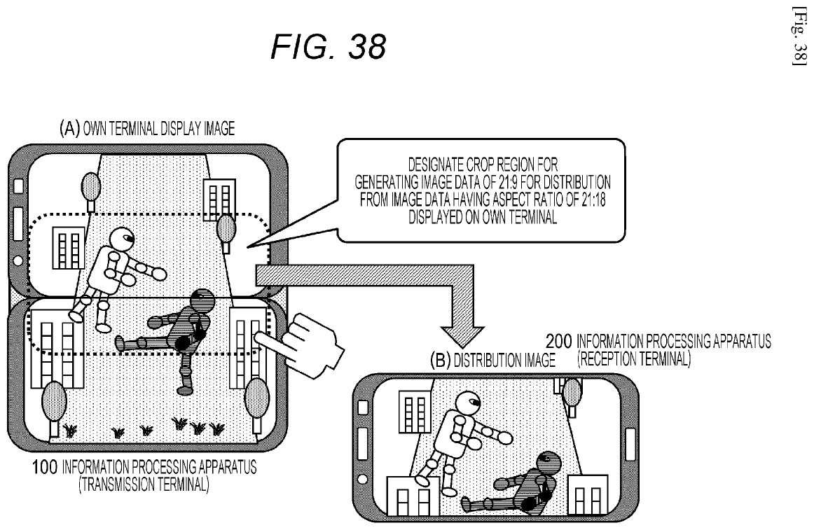

A specific processing example when this processing is performed will be described with reference to FIG. 38.

(A) An own terminal display image of FIG. 38 illustrates an example in which a game execution screen of one game application is displayed using display regions of all two screens of the information processing apparatus (transmission terminal) 100 having the two-screen configuration.

This game application is, for example, an application provided by the management server (game application distribution server) 50, and is a game application including an image with an aspect ratio of 21:18.

The distribution user 20 selects an arbitrary region from the game execution screen displayed in the display region of all the two screens of the information processing apparatus (transmission terminal) 100 having the two-screen configuration. For example, the dotted region illustrated in the drawing is cropped. By this crop processing, an image for distribution, for example, a distribution image having an aspect ratio of 21:9 is cut and distributed.

Note that the user operation for the crop process is performed by, for example, processing of tracking a frame (dotted line frame illustrated in the drawing) that roughly defines the crop region with a finger, processing of tapping a central portion of an image region to be distributed, or the like.

In response to these user operations, the information processing apparatus executes image cropping processing (crop processing) according to a preset aspect ratio of the distribution image to generate and distribute the distribution image.

### (6. Voice Output Control Processing of Information Processing Apparatus)

Next, voice output control processing of the information processing apparatus will be described.

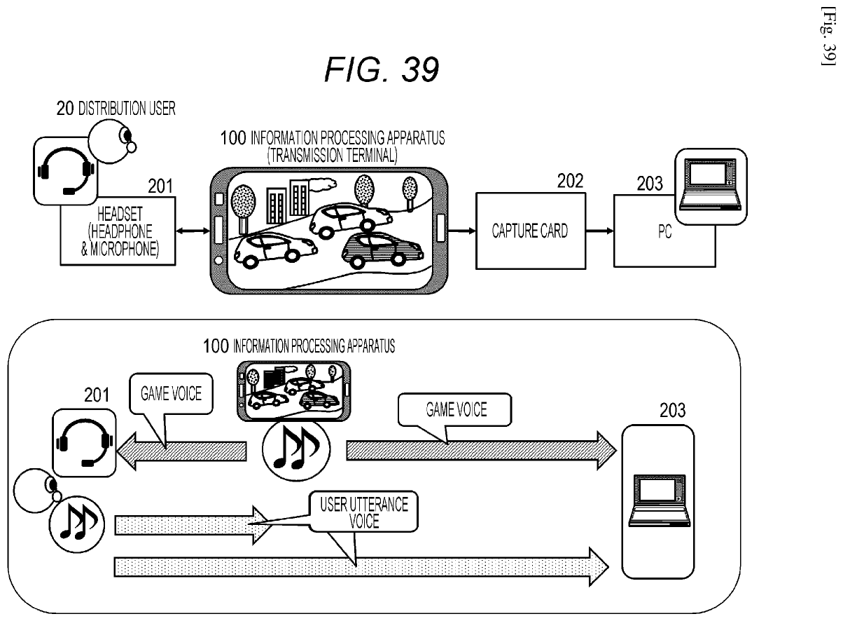

An example of voice output control executed by the information processing apparatus (transmission terminal) 100 of the present disclosure will be described with reference to FIG. 39.

A game execution screen of a game executed by the distribution user 20 is displayed on the display unit of the information processing apparatus (transmission terminal) 100 illustrated in FIG. 39.

The distribution user 20 is listening to a game voice of the game being executed in the information processing apparatus (transmission terminal) 100 via a headset 201. The headset 201 includes a microphone and a speaker.

The headset 201 is connected to an analog voice input/output unit of a 3.5 mm audio jack and the like of information processing apparatus (transmission terminal) 100.

Analog audio data of the game sound is output from the information processing apparatus (transmission terminal) 100 to the headset 201, and the distribution user 20 can listen to the game sound through the speaker of the headset 201.

Furthermore, the voice of the distribution user 20, for example, the gaming commentary voice is input from the microphone of the headset 201 to the information processing apparatus (transmission terminal) 100 via the analog voice input/output unit of the information processing apparatus (transmission terminal) 100.

Moreover, a digital data output unit of the information processing apparatus (transmission terminal) 100, for example, a digital data output unit of a Type-C USB output unit and the like, and the PC 203 are connected via a capture card 202. An input of the capture card 202 is, for example, an HDMI (registered trademark) input unit.

That is, these pieces of data of (a) game image, (b) audio data of game, and (c) game commentary voice of the distribution user are output from the digital data output unit (capture card connection unit) of the information processing apparatus (transmission terminal) 100 and input to the PC 203 via the capture card 202.

On the basis of the input data, the PC 203 can execute game distribution processing, or perform recording processing of data including a game screen, a voice, and a commentary sound.

As described above, the information processing apparatus (transmission terminal) 100 of the present disclosure is configured to execute audio input/output processing via an analog voice input/output unit of a 3.5 mm audio jack and the like, for example, and digital data output processing including audio data via a digital data output unit such as Type-C USB, for example, in parallel.

With this configuration, the distribution user 20 can output the image and voice of the game and the voice of the distribution user 20 to the PC 203 while listening to the voice of the game application via the headset 201, and perform live distribution of the game, game recording processing, and the like via the PC 203.

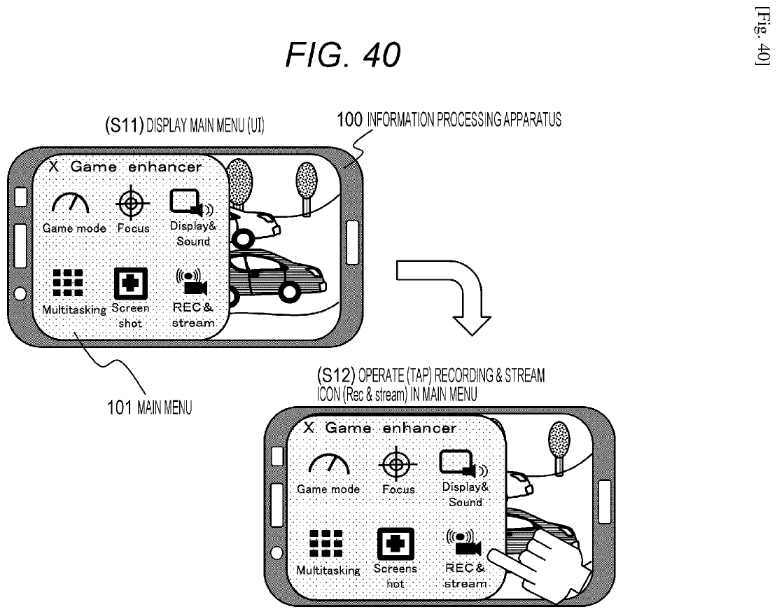

An operation example in the case of executing such audio output setting processing will be described with reference to FIG. 40 and subsequent drawings.

First, as illustrated in FIG. 40 (Step S11), the main menu (UI) 101 is displayed on the display unit of the information processing apparatus 100.

As described above with reference to FIGS. 3 to 4, for example, the main menu (UI) 101 is displayed by performing flick processing of sliding the finger from the upper part toward the lower part of the screen of the information processing apparatus 100.

Next, in (Step S12), the recording & stream icon (Rec & stream) displayed in the main menu 101 is selected and operated (tapped).

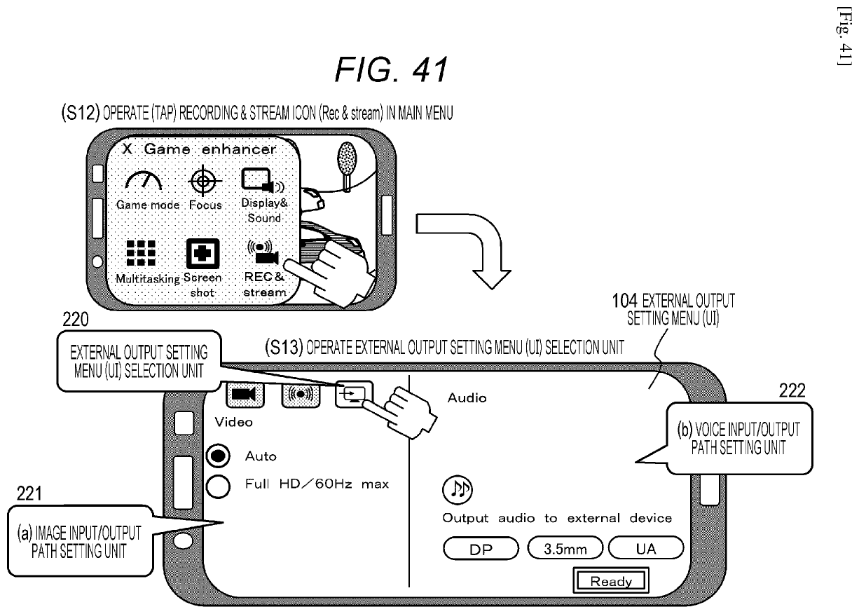

Next, as illustrated in the lower right part (Step S13) of FIG. 41, an external output setting menu (UI) selection unit 220 at the upper left end is operated (tapped). By this icon selection processing, an external output setting menu (UI) 104 is displayed.

As shown in FIG. 41, these two types of setting units of (a) an image input/output path setting unit 221 and (b) a voice input/output path setting unit 222 are displayed in the external output setting menu (UI) 104.

Here, processing using the “(b) voice input/output path setting unit 222” will be described.

Note that the distribution user 20 can sequentially display various setting items in the “(b) voice input/output path setting unit 222” by scrolling the screen of the information processing apparatus 100.

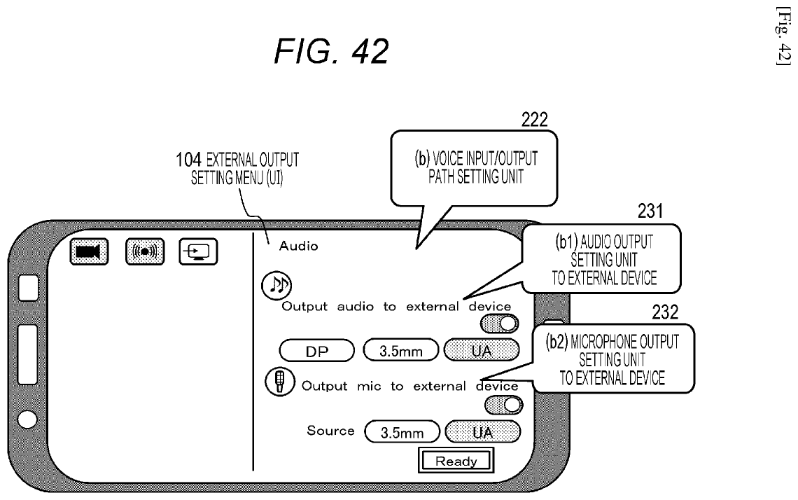

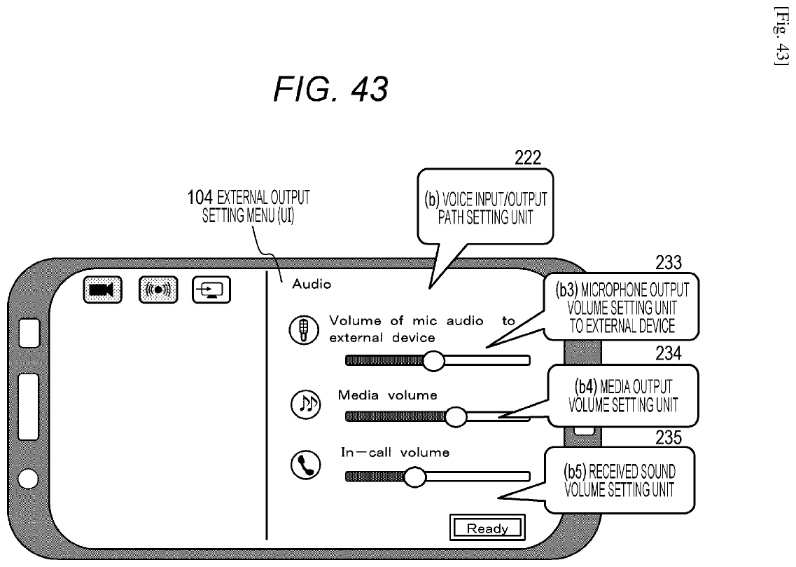

A specific example of the setting processing of the voice input/output path using the “(b) voice input/output path setting unit 222” will be described with reference to FIGS. 42 and 43.

First, when the distribution user 20 scrolls the screen of the “(b) voice input/output path setting unit 222” illustrated in FIG. 41, the setting items illustrated in FIG. 42 are displayed.

On the screen of the “(b) voice input/output path setting unit 222” illustrated in FIG. 42, the following setting units are displayed.
(b1) Audio output setting unit 231 to external device
(b2) Microphone output setting unit 232 to external device

The “(b1) audio output setting unit (output audio external device) 231 to the external device” is, for example, a setting unit for selecting whether or not to execute audio output to an external device of the headset 201 or the PC 203 and the like described with reference to FIG. 39.

Three types of DP, 3.5 mm, and UA are selectable as options, and two types of DP and 3.5 mm are selected in the example illustrated in the drawing.

The DP is a display port and is a digital output port connected to the capture card 202 in the example illustrated in FIG. 39.

3.5 mm denotes a 3.5 mm jack, which is an analog input/output unit connected to headset 201 in the example illustrated in FIG. 39.

UA is a USB audio output unit.

The setting state of the “(b1) audio output setting unit 231 to external device” in FIG. 42 is a state in which two of DP and 3.5 mm are selected. With this setting, audio output via the two audio output units described above with reference to FIG. 39 becomes possible.

That is, audio input/output processing via an analog voice input/output unit of a 3.5 mm audio jack and the like and digital data output processing including audio data via a digital data output unit of Type-C USB and the like, for example can be executed in parallel.

The “(b2) a microphone output setting unit (output mic external device) 232 to the external device” is a setting unit that sets whether or not to output a microphone voice to the external device of the PC 203 and the like described with reference to FIG. 39, for example, and can further select a microphone input (source).

As a microphone input (source) option, 3.5 mm and UA can be selected, and whether or not to individually output each microphone input (source) can be set. 3.5 mm denotes a 3.5 mm jack, which is an analog input/output unit connected to headset 201 in the example illustrated in FIG. 39.

UA is a USB audio output unit.

In the example illustrated in FIG. 42, 3.5 mm is selected. With this setting, as described above with reference to FIG. 39, the information processing apparatus 100 can output the microphone voice input from the headset 201 to the external device of the PC 203 and the like.

The setting screen illustrated in FIG. 43 is displayed by further scrolling the screen of the “(b) voice input/output path setting unit 222” illustrated in FIG. 42.

On the screen of the “(b) voice input/output path setting unit 222” illustrated in FIG. 43, a volume setting unit that adjusts a volume balance of each audio to be output to an external device of the PC 203 and the like illustrated in FIG. 39 is displayed. Specifically, the setting units are as follows.
(b3) Microphone output volume setting unit 233 to external device
(b4) Media output volume setting unit 234
(b5) Received sound volume setting unit 235

For example, the voice output from the information processing apparatus 100 to the PC 203 in the configuration described with reference to FIG. 39 is a voice obtained by mixing a plurality of voices. Therefore, when any one of the sound volumes is too large, a problem that other sounds may not be heard occurs.

In order to solve such a problem, the volume balance of each sound is adjusted by making the volume of each sound (each sound source) adjustable. The UI illustrated in FIG. 43 is a UI for volume adjustment processing of each sound (each sound source), and can individually adjust the output volume of each sound source.

Note that the output sound setting processing in the information processing apparatus 100 of the present disclosure can be executed not only using the UI launched from the game application start screen but also in a state where the game application is not activated.

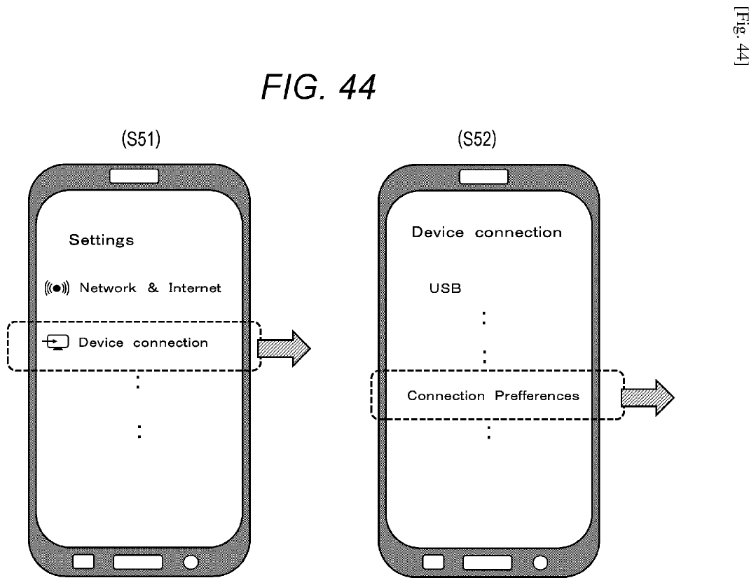

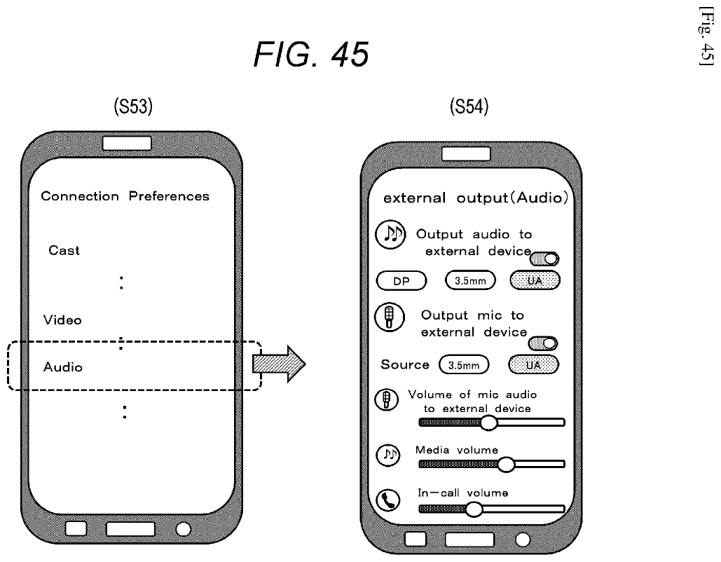

Specifically, for example, by performing processing as illustrated in FIGS. 44 and 45, it is possible to display and set the UI for setting the output sound for the external device.

A specific processing sequence is, for example, as follows.
(Step S51) Select device connection from setting menu
(Step S52) Select connection preference from device connection menu
(Step S53) Select audio from connection preference menu
(Step S54) Execution of setting of each audio in audio menu

The audio menu illustrated in (Step S54) of FIG. 45 is a UI that enables audio setting similar to that of the external output setting menu 104 described above with reference to FIGS. 42 and 43.

As described above, the output sound setting processing in the information processing apparatus 100 of the present disclosure can be executed not only by using the UI launched from the game application start screen but also by performing the output sound setting processing even in a state where the game application is not started.

As described above, the information processing apparatus 100 of the present disclosure can adjust the output volume (volume) of each sound source and output the adjusted output volume to an external device of a PC and the like.

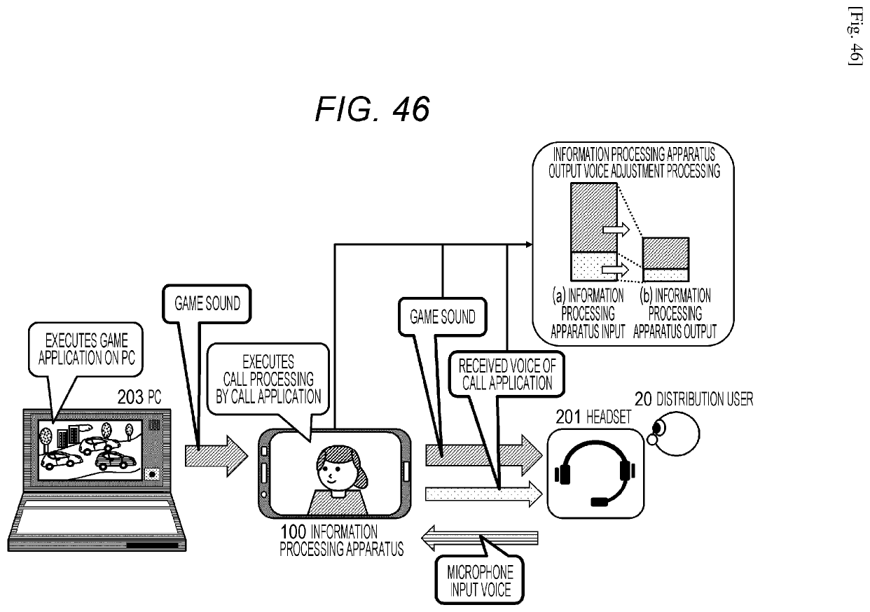

A specific processing example to which the output voice control processing is applied will be described with reference to FIG. 46 and subsequent drawings.

FIG. 46 illustrates the headset 201 as the external device described above with reference to FIG. 39 and the PC 203 in addition to the information processing apparatus 100.

In the configuration illustrated in FIG. 46, the distribution user 20 executes the game application on the PC 203, and further executes a call (video call) using a call application using the information processing apparatus 100 of a smart phone and the like.

A game sound is input from the PC 203 to the information processing apparatus 100. Furthermore, the utterance voice of the distribution user 20 executing the call application using the information processing apparatus 100 is input from the microphone of the headset 201 to the information processing apparatus 100.

In this state, the information processing apparatus 100 outputs the following two different audios, that is, two different pieces of audio data of (a) an input sound (game sound) from PC 203 and (b) a received voice of the call application which is a voice of a calling party received by the call application being executed in the information processing apparatus 100 to the headset 201 worn by the distribution user 20.

In a case where such processing is performed, the output volume (volume) of each sound source is adjusted using the external output setting menu (UI) described above with reference to FIG. 43 and the like, so that audio data with an optimum balance can be output from the information processing apparatus 100 to the headset 201.

“Information processing apparatus output voice adjustment processing” illustrated in the upper right part of FIG. 46 illustrates an example of the output voice adjustment processing.

“(a) Information processing apparatus input” illustrated in the drawing indicates the volume of two sound sources as the height.

The upper side corresponds to the volume of the game sound input from the PC 203. The lower side corresponds to the volume of the received voice of the call application.

In the information processing apparatus 100, by adjusting the output volume of each sound source using the external output setting menu (UI) described above with reference to FIG. 43 and the like, audio data with an optimum balance can be generated as in the “(b) information output apparatus output” illustrated in the drawing, and this data can be output from the information processing apparatus 100 to the headset 201.

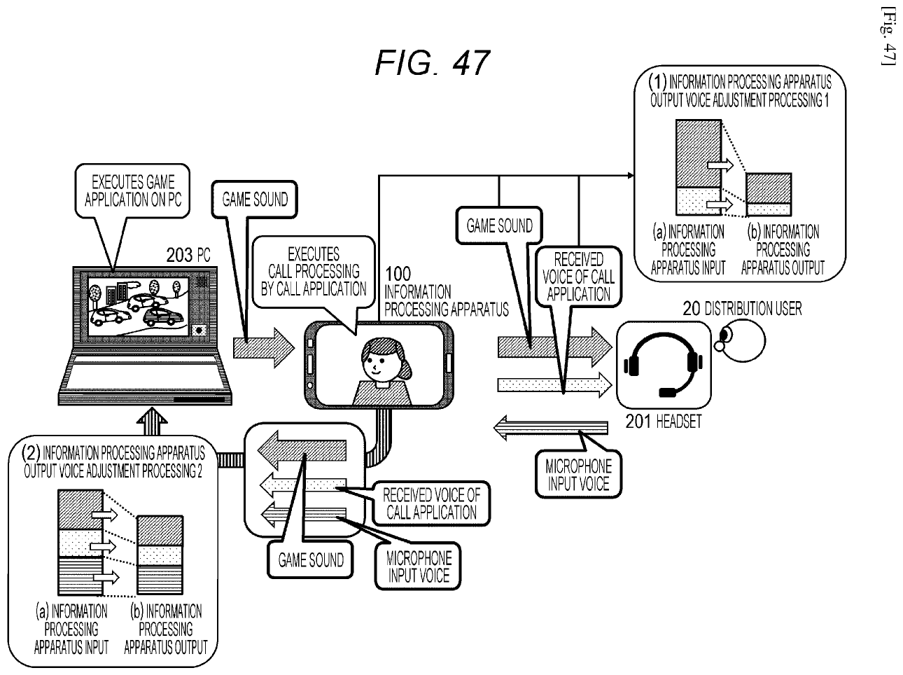

Furthermore, as illustrated in FIG. 47, the information processing apparatus 100 can also control audio data to be output to the PC 203.

“(2) Information processing apparatus output voice adjustment processing” illustrated in the lower left part of FIG. 47 illustrates an example of the output voice adjustment processing.

The audio data output from the information processing apparatus 100 to the PC 203 includes three types of audio data of (1) a game sound, (2) a received voice of the call application, and (3) a microphone input voice.

The “(a) information processing apparatus input” in the “(2) information processing apparatus output voice adjustment processing” illustrated in the lower left part of FIG. 47 indicates the volumes of the three sound sources described above as the height. The top portion corresponds to the game sound, the middle portion corresponds to the reception voice of the call application, and the bottom portion corresponds to the volume of the microphone input voice.

In the information processing apparatus 100, by adjusting the output volume of each sound source using the external output setting menu (UI) described above with reference to FIG. 43 and the like, it is possible to generate audio data of an optimum balance as illustrated in the “(b) information output apparatus output” in the “(2) information processing apparatus output voice adjustment processing” illustrated in the lower left part of FIG. 47, and output the data from the information processing apparatus 100 to the PC 203, and output the data from the speaker of the PC 203 or record the data in the storage unit of the PC 203.

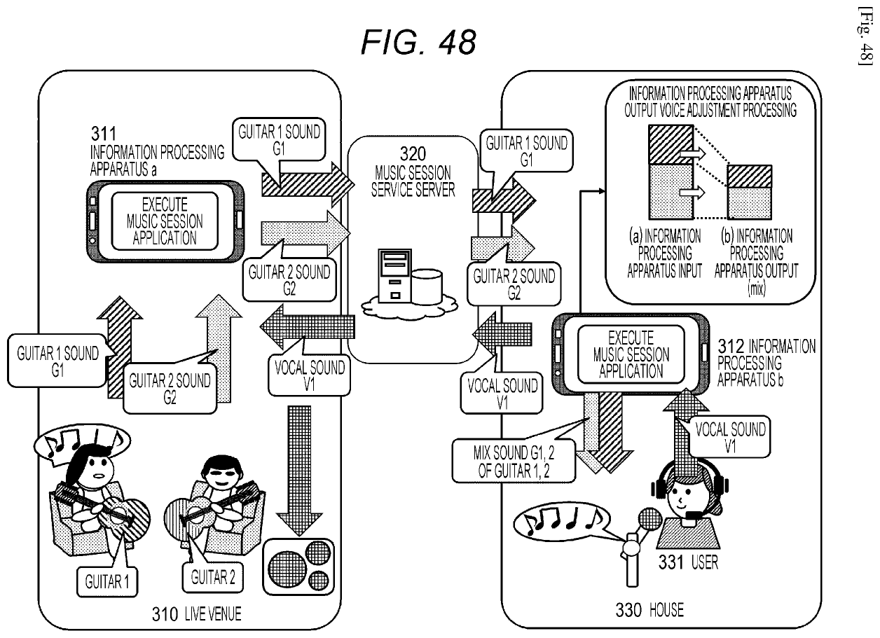

Furthermore, another specific processing example to which the output voice control processing executed in the information processing apparatus 100 of the present disclosure is applied will be described with reference to FIG. 48 and subsequent drawings.

FIG. 48 illustrates an example in which a music session is held at two remote places, that is, a live venue 310 and a house 330.

In the live venue 310, a guitar 1 and a guitar 2 are played. Meanwhile, in the house 330, there is a user 331 who sings along with the guitar performance.

Information processing apparatuses a and 311 are placed in the live venue 310, and information processing apparatuses b and 312 are placed in the house 330. These information processing apparatuses can perform audio control processing similar to that of the information processing apparatus (transmission terminal) 100 described above. That is, it is a device capable of performing the audio control processing using the UI described with reference to FIGS. 40 to 45.

The information processing apparatuses a and 311 in the live venue 310 and the information processing apparatuses b and 312 in the house 330 each execute a music session application provided by the music session service server 320, and are set to be able to communicate with each other via the music session service server 320.

The guitar sound 1 of the guitar 1 and the guitar sound 2 of the guitar 2 at the live venue 310 are input to the information processing apparatuses a and 311, and are transmitted from the information processing apparatuses a and 311 to the information processing apparatuses b and 312 of the house 330 via the music session service server 320.

This guitar sound is output from the information processing apparatuses b and 312 to a headset worn by the user 331 who sings a song, and the user 331 can sing while listening to the guitar sound from the headset.

Furthermore, a vocal sound V1, which is a song of the user 321, is input from the microphone of the headset to the information processing apparatuses b and 312, and is transmitted from the information processing apparatuses b and 312 to the information processing apparatuses a and 311 in the live venue 310 via the music session service server 320.

The information processing apparatuses a and 311 output the vocal sound V1 received from the music session service server 320 via a speaker near a guitar player.

With this processing, the guitar player can play along with the vocal sound V1 of the user 331.

In such a music session, for example, the information processing apparatuses b and 312 of the house 330 inputs the guitar sound 1 of the guitar 1 and the guitar sound 2 of the guitar 2 in the live venue 310 via the music session service server 320, and outputs the input guitar sound to the headset worn by the user 331.

The information processing apparatuses b and 312 executes the output voice adjustment processing of the guitar sound.

“Information processing apparatus output voice adjustment processing” illustrated in the upper right of FIG. 48 illustrates an example of the output voice adjustment processing.

“(a) Information processing apparatus input” illustrated in the drawing indicates the volume of two sound sources as the height.

The upper side corresponds to a volume of a guitar 1 sound G1 which is the sound of the guitar 1. The lower side corresponds to a volume of a guitar 2 sound G2 which is the sound of the guitar 2.

In the information processing apparatuses b and 312, by adjusting the output volume of each sound source using the external output setting menu (UI) described above with reference to FIG. 43 and the like, it is possible to generate audio data of an optimum balance as in the “(b) information output apparatus output” in the “information processing apparatus output voice adjustment processing” illustrated in the upper right of FIG. 48, and output this data from the information processing apparatuses b and 312 to the headset worn by the user 331.

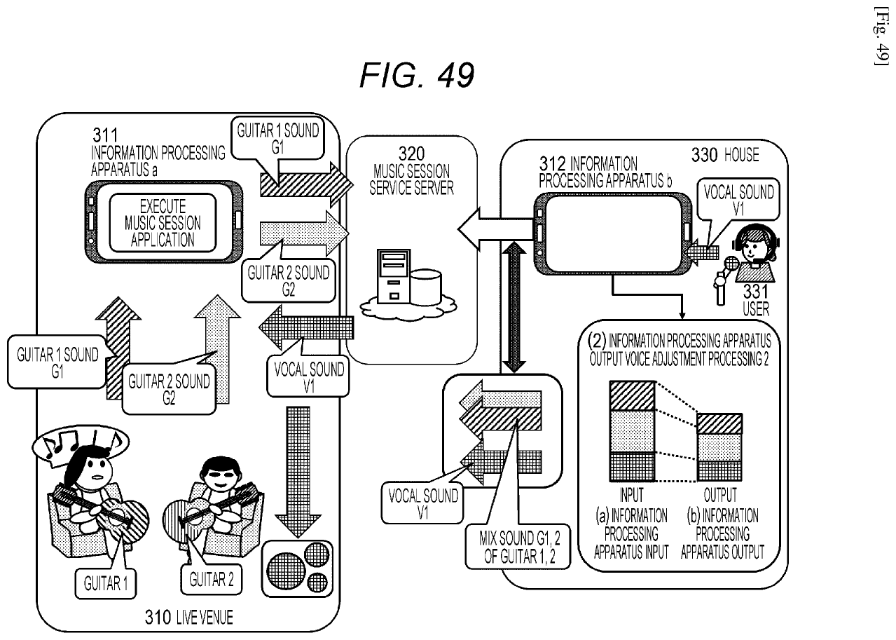

Furthermore, as illustrated in FIG. 49, the information processing apparatuses b and 312 can execute volume adjustment processing of three pieces of audio data of the vocal sound V1, the guitar 1 sound G1 that is the voice of the guitar 1, and the guitar 2 sound G2 that is the voice of the guitar 2 in the information processing apparatuses b and 312, and transmit output audio data generated as a result of the execution to, for example, the music session service server 320. The music session service server 320 can perform processing of distributing the received music session data to a large number of terminals or processing of recording the received music session data in a storage unit.

The “(2) information processing apparatus output voice adjustment processing” illustrated in FIG. 49 is an example of the output voice adjustment processing executed by the information processing apparatuses b and 312 in the processing described above.

The audio data output from the information processing apparatuses b and 312 to the music session service server 320 includes three types of audio data of (1) guitar 1 sound G1 which is the sound of guitar 1, (2) guitar 2 sound G2 which is the sound of guitar 2, and (3) vocal sound V1.

The “(a) information processing apparatus input” in “(2) the information processing apparatus output voice adjustment processing” illustrated in FIG. 49 indicates the sound volumes of the three sound sources described above as the heights. The top portion corresponds to the volume of the guitar 1 sound G1, the middle portion corresponds to the volume of the guitar 2 sound G2, and the bottom portion corresponds to the volume of the vocal sound V1.

In the information processing apparatuses b and 312, the output volume of each sound source is adjusted using the external output setting menu (UI) described above with reference to FIG. 43 and the like, so that it is possible to generate audio data of an optimum balance as illustrated in the “(b) information output apparatus output” in the “(2) information processing apparatus output voice adjustment processing” illustrated in FIG. 49.

The information processing apparatuses b and 312 transmit this data to the music session service server 320.

The music session service server 320 can perform processing of distributing the music session data received from the information processing apparatuses b and 312 to a large number of terminals or processing of recording the music session data in the storage unit.

### (7. Configuration Example of Information Processing Apparatus)

Next, a configuration example of the information processing apparatus will be described.

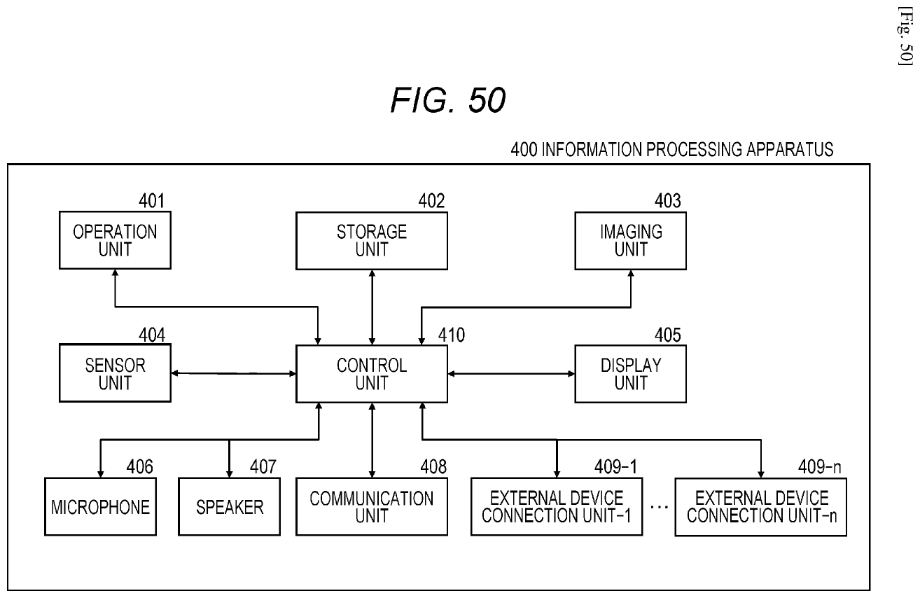

FIG. 50 is a block diagram illustrating a functional configuration of the information processing apparatus 400 of the present disclosure, that is, an information processing apparatus that is a user terminal of a smartphone and the like.

Note that the information processing apparatus 400 illustrated in FIG. 50 corresponds to the information processing apparatus (transmission terminal) 100 and the information processing apparatus (reception terminal) 200 described above with reference to FIG. 1 and the like, and further corresponds to the information processing apparatuses a and 311 and the information processing apparatuses b and 312 described with reference to FIG. 48 and the like.

As illustrated in FIG. 50, the information processing apparatus 400 includes an operation unit 401, a storage unit 402, an imaging unit 403, a sensor unit 404, a display unit 405, a microphone 406, a speaker 407, a communication unit 408, external device connection units 1 to n and 409-1 to 409-n, and a control unit 410.

The operation unit 401 detects various operations by the user, such as a device operation for an application.

Examples of the operation described above include a touch operation and processing of connecting an external device to the information processing apparatus 100.

Here, the touch operation refers to various touch operations on the display unit 405, such as tapping, double tapping, swiping, and pinching.

Furthermore, the touch operation includes an operation of bringing an object such as a finger close to the display unit 405, for example.

For this purpose, the operation unit 401 includes, for example, a touch panel, a button, a keyboard, a mouse, a proximity sensor, and the like. Furthermore, the operation unit 401 inputs information regarding the detected operation of the user to the control unit 410.

The storage unit 402 is a storage area for temporarily or permanently storing various programs and data.

For example, the storage unit 402 stores programs and data for the information processing apparatus 100 to execute various functions. As a specific example, the storage unit 402 stores programs for executing various applications, management data for managing various settings, and the like.

For example, setting information set by the user for various menus (UI) such as the preset menu before data distribution (UI) 102, the setting menu during data distribution (UI) 103, and the external output setting menu (UI) 104 described above is recorded.

However, the above is merely an example, and the type of data stored in the storage unit 402 is not particularly limited.

The imaging unit 403 images, for example, the face of the user operating the information processing apparatus 100 or the like on the basis of the control by the control unit 410.

The imaging unit 403 includes an imaging element. A smartphone, which is an example of the information processing apparatus 100, includes a front camera for imaging a user's face or the like on the display unit 405 side and a main camera for imaging a landscape or the like on the back side of the display unit 405. In the present embodiment, imaging by the front camera is controlled as an example.

The sensor unit 404 has a function of collecting sensor information regarding user's behavior using various sensors. The sensor unit 404 includes, for example, an acceleration sensor, a gyro sensor, a geomagnetic sensor, a vibration sensor, a global navigation satellite system (GNSS) signal reception device, and the like.

For example, the sensor unit 404 detects that the user holds the information processing apparatus 100 laterally by using a gyro sensor, and inputs the detected information to the control unit 410.

The display unit 405 displays various types of visual information on the basis of control by the control unit 410. The display unit 405 may display, for example, an image, a character, or the like related to the application.

The display unit 405 may include various display devices such as a liquid crystal display (LCD) device and an organic light emitting diode (OLED) display device.

Furthermore, on the display unit 405, under the control of the control unit 410, various menus (UI) are superimposed and displayed on a layer higher than the screen of the display application.

The microphone 406 includes a microphone or the like that collects a voice or the like uttered by the user on the basis of control by the control unit 410.

The speaker 407 outputs various sounds. For example, a voice or a sound according to the situation of the application is output on the basis of control by the control unit 410.

The communication unit 408 functions as a transmission/reception unit for, for example, Wi-Fi communication, Bluetooth (registered trademark) (BT) communication, and other data communication via a network such as the Internet or a local area network, and communicates with an external device.

For example, a process of distributing various data of a game and the like to the outside is executed.

The external device connection units-1 to -n 409-1 to -n are connection units used for connection with the headset 201, the PC 203, the capture card 202, and the like described above with reference to FIG. 39 and the like, and specifically include, for example, an analog voice input/output unit such as a 3.5 mm audio jack, a digital data output unit such as a Type-C USB output unit, and the like.

The control unit 410 controls, for example, display data to be output to the display unit 405 and transmission data to be transmitted via the communication unit 408.

Furthermore, the control unit 410 executes processing of displaying various menus (UI) on the display unit 405 and processing of recording, in the storage unit 402, setting of distribution data according to a user operation on the displayed menu (UI) on the basis of a user operation on the operation unit 401.

Further, when performing data distribution via the communication unit 408, the control unit 410 determines and distributes the specification of the distribution data (image, audio) according to the setting information recorded in the storage unit 402.

Note that the menus displayed on the display unit 405 under the control of the control unit 410 are, for example, the menus of the preset menu before data distribution (UI) 102, the setting menu during data distribution (UI) 103, the external output setting menu (UI) 104, and the like described above.

The control unit 410 records setting information set by the user for these various menus (UI) in the storage unit 402.

When data distribution is performed via the communication unit 408, a specification of the distribution data (IMAGE, AUDIO) is determined according to the setting information recorded in the storage unit 402 and distributed.

Specific processes controlled by the control unit 110 include, for example, the following processes (a) to (d).

(a) The display image to be output to the display unit 405 and the transmission image are generated as two different types of images. For example, two types of images having different aspect ratios, resolutions, or frame rates are generated, one of the generated two types of images is displayed on the display unit 405, and the other is transmitted via the communication unit 408.

(b) In a case where the information processing apparatus 100 is oriented horizontally, a transmission image having a lateral layout determined according to a user operation is generated and transmitted. In a case where the information processing apparatus 100 is oriented vertically, a transmission image having a vertical layout determined according to a user operation is generated and transmitted.

(c) Audio data in which the volume of each sound source is adjusted is generated and transmitted according to the volume of a sound source unit determined according to the user operation on the audio adjustment menu displayed on the display unit 105.

Note that, in a case where the setting is changed according to the user operation on the setting menu during data distribution, the volume of each sound source is changed according to the new setting and transmitted.

(d) Image display control is executed to switch display data for the display unit 105 from a display image of a specification set in advance according to a user operation to a transmission image transmitted via the communication unit 408.

Although the functional configuration example of the information processing apparatus 400 has been described above, the functional configuration described above with reference to FIG. 50 is merely an example, and the functional configuration of the information processing apparatus 100 according to the present embodiment is not limited to such an example.

For example, the information processing apparatus 400 may not necessarily include all of the configurations illustrated in FIG. 50, and some of the configurations may be included in another apparatus different from the information processing apparatus 400.

The functional configuration of the information processing apparatus 400 according to the present embodiment can be flexibly modified according to specifications and operations.

Furthermore, the function of each component may be performed by reading a control program from storage media such as a read only memory (ROM) and a random access memory (RAM) storing a control program describing a processing procedure for an arithmetic device such as a central processing unit (CPU) to realize these functions, and interpreting and executing the program.

Therefore, it is possible to change the configuration to be used as appropriate according to the technical level at which the present embodiment is implemented.

### (8. Hardware Configuration Example of Information Processing Apparatus and Server)

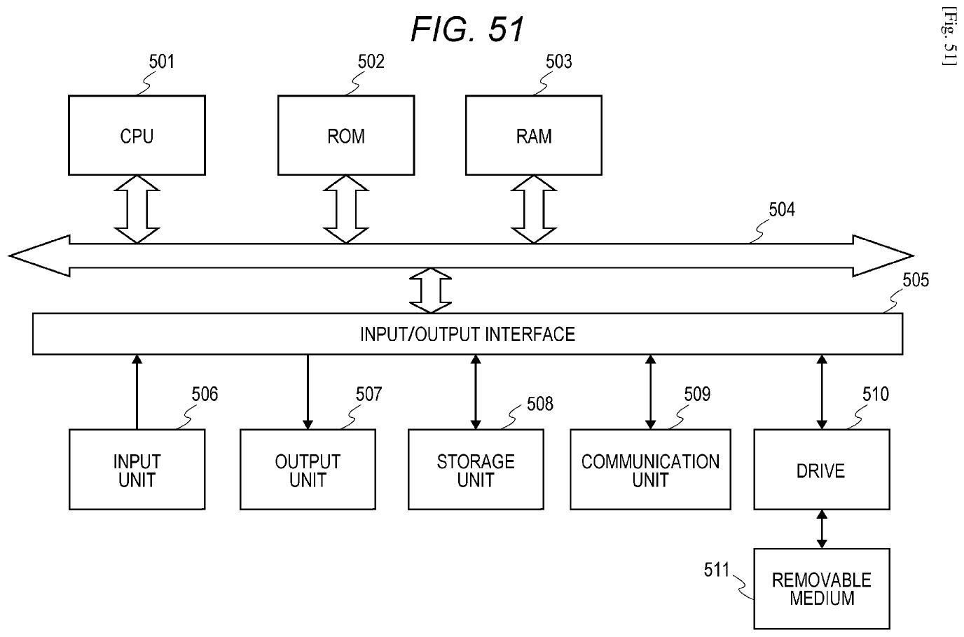

Next, a hardware configuration example of a device that can be used as an information processing apparatus or a management server will be described with reference to FIG. 51.

Note that the hardware of the information processing apparatus illustrated in FIG. 51 corresponds to the hardware of the information processing apparatus (transmission terminal) 100 and the information processing apparatus (reception terminal) 200 described above with reference to FIG. 1 and the like, and further corresponds to the hardware of the information processing apparatuses a and 311 and the information processing apparatuses b and 312 described with reference to FIG. 48 and the like. Furthermore, the hardware corresponds to the hardware of the management server 50 described with reference to FIG. 1 and the like, and the music session service server 320 described with reference to FIG. 48 and the like.

Each component constituting the hardware of the information processing apparatus illustrated in FIG. 51 will be described below.

A central processing unit (CPU) 501 functions as a control unit or a data processing unit that executes various processes according to a program stored in a read only memory (ROM) 502 or a storage unit 508. For example, processing according to the sequence described in the above-described embodiment is executed. A random access memory (RAM) 503 stores programs executed by the CPU 501, data, and the like. The CPU 501, the ROM 502, and the RAM 503 are mutually connected by a bus 504.

The CPU 501 is connected to an input/output interface 505 via a bus 504, and an input unit 506 including various switches, a keyboard, a mouse, a microphone, and the like, and an output unit 507 that executes data output to a display unit, a speaker, and the like are connected to the input/output interface 505. The CPU 501 executes various processes in response to commands input from the input unit 506, and outputs processing results to the output unit 507, for example.

The storage unit 508 connected to the input/output interface 505 includes, for example, a hard disk and the like, and stores programs executed by the CPU 501 and various data. The storage unit 508 includes a non-transitory computer readable storage device for storing programs executed by the CPU 501. The communication unit 509 functions as a transmission/reception unit for Wi-Fi communication, Bluetooth (registered trademark) (BT) communication, and other data communication via a network such as the Internet or a local area network, and communicates with an external device.

A drive 510 connected to the input/output interface 505 drives a removable medium 511 such as a magnetic disk, an optical disk, a magneto-optical disk, or a semiconductor memory of a memory card and the like, and records or reads data.

### (9. Summary of Configuration of Present Disclosure)

Hereinabove, the embodiments of the present disclosure have been described in detail with reference to specific embodiments. However, it is obvious that those skilled in the art can make modifications and substitutions of the embodiments without departing from the gist of the present disclosure. That is, the present disclosure has been disclosed in the form of exemplification, and should not be interpreted in a limited manner. In order to determine the gist of the present disclosure, the claims should be taken into consideration.

Note that the technology disclosed in the present specification can have the following configurations.

(1)

An information processing apparatus for live streaming an application being used by a user of the information processing apparatus from the information processing apparatus to a reception terminal, the information processing apparatus being configured to display a preset menu to preset a distribution image to be transmitted from the information processing apparatus to the reception terminal before the live streaming is executed, the distribution image including a first region in which the application is to be streamed and a second region in which other information is to be displayed, the preset menu including at least one of a transmission setting unit to preset transmission data for transmitting the first region to the reception terminal in response to a transmission data selection by the user, a display setting unit to preset display data for the second region in response to a display data selection by the user, and a layout setting unit to preset a layout for the first region and the second region in the distribution image in response to a layout selection by the user. The information processing apparatus is configured to display a distribution start input, wherein, in response to a user activation of the distribution start input, execute the application on the information processing apparatus, and generate and transmit the distribution image to the reception terminal, wherein the distribution image transmitted to the reception terminal is different from a view of the application on the information processing apparatus during execution of the application.

(2)

The information processing apparatus according to (1), wherein the transmission setting unit is configured to transmit an image for the first region having different aspect ratios, resolutions, or frame rates, from that of the view of the application on the information processing apparatus during the execution of the application.

(3)

The information processing apparatus according to (1) or (2), further comprising: a control unit configured to display an image having an aspect ratio that is displayed in an entire region of a two-screen display unit of the information processing apparatus during execution of the application, and wherein the transmission setting unit is configured to transmit an image for the first region having an aspect ratio that is displayed on a one-screen display unit.

(4)

The information processing apparatus according to any one of (1) to (3), further comprising a storage unit configured to store information set by the user for the distribution image.

(5)

The information processing apparatus according to any one of (1) to (4), wherein the layout setting unit is to preset a vertical layout and a horizontal layout for the distribution image in response to a vertical layout selection and a horizontal layout selection by the user.

(6)

The information processing apparatus according to (5), wherein the layout setting unit is configured to display a plurality of different vertical layouts for a user to select and a plurality of different horizontal layouts for the user to select.

(7)

The information processing apparatus according to (5), wherein the information processing apparatus is configured to generate and transmit the distribution image having the horizontal layout on condition that the information processing apparatus is horizontally oriented, and generate and transmit the distribution image having the vertical layout on condition that the information processing apparatus is vertically oriented.

(8)

The information processing apparatus according to claim any one of (1) to (7), wherein the layout setting unit is configured to display a plurality of different layouts for a user to select.

(9)

The information processing apparatus according to any one of (1) to (8), wherein the preset menu is configured to process at least one of text in the first region, the second region, and a background in the first region.

(10)

The information processing apparatus according to any one of (1) to (9), wherein the preset menu is configured to edit text in the second region.

(11)

The information processing apparatus according to any one of (1) to (10), wherein the preset menu further includes a thumbnail editing unit configured to edit a thumbnail of the distribution image, and the information processing apparatus is configured to generate and transmit the thumbnail of the distribution image determined according to a user operation on the thumbnail editing unit.

(12)

The information processing apparatus according to (11), wherein the thumbnail editing unit is configured to edit at least one of text in the second region, the first region, and a background of the second region in the thumbnail.

(13)

The information processing apparatus according to any one of (1) to (12), wherein the preset menu further includes an audio adjustment menu for adjusting audio data for the transmission data, and the audio adjustment menu is configured to adjust a volume of a sound source unit constituting audio data included in the transmission data.

(14)

The information processing apparatus according to (13), wherein the information processing apparatus is configured to generate and transmit audio data obtained by adjusting a volume of each sound source according to the volume of the sound source unit determined according to a user operation on the audio adjustment menu with the distribution image to the reception terminal.

(15)

The information processing apparatus according to any one of (1) to (14), wherein the information processing apparatus is configured to execute image display control to switch from the view of the application on the information processing apparatus during execution of the application to the distribution image in accordance with a view selection by the user.

(16)

The information processing apparatus according to any one of (1) to (15), wherein the information processing apparatus is further configured to generate and transmit audio data with the distribution image to the reception terminal.

(17)

The information processing apparatus according to any one of (1) to (16), wherein the information processing apparatus is configured to display a setting menu during transmission of the distribution image for executing setting of the transmission data, store setting information corresponding to a user operation on the setting menu, and change setting of transmission data according to setting information stored and transmit a changed distribution image based on changed transmission data.

(18)

The information processing apparatus according to (17), wherein the setting menu during transmission of the distribution image includes an audio adjustment menu for adjusting audio data in the transmission data, the audio adjustment menu is configured to adjust a volume of a sound source unit constituting audio data included in the transmission data, and the information processing apparatus is configured to generate and transmit audio data in which a volume of each sound source is changed according to a volume of a sound source unit changed according to a user operation on the audio adjustment menu.

(19)

An information processing method executed in an information processing apparatus for live streaming an application being used by a user of the information processing apparatus from the information processing apparatus to a reception terminal, the method comprising displaying a preset menu to preset a distribution image to be transmitted from the information processing apparatus to the reception terminal before the live streaming is executed, the distribution image including a first region in which the application is to be streamed and a second region in which other information is to be displayed, the preset menu including at least one of a transmission setting unit to preset transmission data for transmitting the first region to the reception terminal in response to a transmission data selection by the user, a display setting unit to preset display data for the second region in response to a display data selection by the user, and a layout setting unit to preset a layout for the first region and the second region in the distribution image in response to a layout selection by the user; and displaying a distribution start input on the information processing apparatus, wherein, in response to a user activation of the distribution start input, executing the application on the information processing apparatus, and generating and transmitting the distribution image to the reception terminal, wherein the distribution image transmitted to the reception terminal is different from a view of the application on the information processing apparatus during execution of the application.

(20)

A non-transitory computer readable storage having a program stored therein that when executed by an information processing apparatus for live streaming an application being used by a user of the information processing apparatus from the information processing apparatus to a reception terminal, causes the information processing apparatus to display a preset menu to preset a distribution image to be transmitted from the information processing apparatus to the reception terminal before the live streaming is executed, the distribution image including a first region in which the application is to be streamed and a second region in which other information is to be displayed, the preset menu including at least one of a transmission setting unit to preset transmission data for transmitting the first region to the reception terminal in response to a transmission data selection by the user, a display setting unit to preset display data for the second region in response to a display data selection by the user, and a layout setting unit to preset a layout for the first region and the second region in the distribution image in response to a layout selection by the user, and display a distribution start input on the information processing apparatus, wherein, in response to a user activation of the distribution start input, execute the application on the information processing apparatus, and generate and transmit the distribution image to the reception terminal, wherein the distribution image transmitted to the reception terminal is different from a view of the application on the information processing apparatus during execution of the application.

Furthermore, the series of processing described in the specification can be executed by hardware, software, or a combined configuration of both. In the case of executing processing by software, a program recording a processing sequence can be installed and executed in a memory in a computer incorporated in dedicated hardware, or the program can be installed and executed in a general-purpose computer capable of executing various types of processing. For example, the program can be recorded in advance in a recording medium. In addition to installation from the recording medium to the computer, the program can be received via a network such as a local area network (LAN) or the Internet and installed in a recording medium of a built-in hard disk and the like.

Note that the various types of processing described in the specification may be executed not only in time series according to the description but also in parallel or individually according to the processing capability of the device that executes the processing or as necessary. Furthermore, in the present specification, a system is a logical set configuration of a plurality of devices, and is not limited to a system in which devices of respective configurations are in the same housing.

It should be understood by those skilled in the art that various modifications, combinations, sub-combinations and alterations may occur depending on design requirements and other factors insofar as they are within the scope of the appended claims or the equivalents thereof.

### INDUSTRIAL APPLICABILITY

As described above, according to the configuration of an embodiment of the present disclosure, an apparatus and a method for controlling each of display data and transmission data in an information processing apparatus and generating and transmitting transmission data in accordance with preset information generated by a user are implemented.

Specifically, for example, the control unit which performs control of the display data to be output to the display unit and the control of the transmission data to be transmitted via the communication unit is provided.

The control unit generates two types of images in which specifications of a display image constituting the display data and specifications of a transmission image constituting the transmission data are different. For example, an aspect ratio, a resolution, and a frame rate of the transmission data are set in advance, and the transmission data according to the setting is generated and transmitted via the communication unit.

With these pieces of processing, an apparatus and a method for controlling each of the display data and the transmission data in the information processing apparatus and generating and transmitting the transmission data according to the preset information generated by the user are realized.

### REFERENCE SIGNS LIST

10 Information processing system
50 Management server
100 Information processing apparatus (transmission terminal)
101 Main menu
102 Preset menu before data distribution (UI)
103 Setting menu during data distribution (UI)
104 External output setting menu (UI)
120 Delivery preset menu (UI) selection unit
121 Title editing unit
122 Display information editing unit
123 Resolution/frame rate setting unit
124 Viewing permission target setting unit
125 Stream delay setting unit
126 Thumbnail editing/display unit
127 Distribution image editing/display unit
128 Privacy setting screen editing/display unit
129 Microphone setting unit
130 Volume setting unit
131 Extended function setting UI transition unit
181 Audio adjustment unit
182 Privacy setting screen adjustment unit
183 UI display setting unit
184 Display image switching unit
200 Information processing apparatus (reception terminal)
201 Headset
202 Capture card
203 PC
222 Voice input/output path setting unit
311, 312, Information processing apparatus
400 Information processing apparatus
401 Operation unit
402 Storage unit
403 Imaging unit
404 Sensor unit
405 Display unit
406 Microphone
407 Speaker
408 Communication unit
409 External device connection unit
410 Control unit
501 CPU
502 ROM
503 RAM
504 Bus
505 Input/output interface
506 Input unit
507 Output unit
508 Storage unit
509 Communication unit
510 Drive
511 Removable medium

1. An information processing apparatus for live streaming an application being used by a user of the information processing apparatus from the information processing apparatus to a reception terminal, the information processing apparatus being configured to:
display a preset menu to preset a distribution image to be transmitted from the information processing apparatus to the reception terminal before the live streaming is executed, the distribution image including a first region in which the application is to be streamed and a second region in which other information is to be displayed, the preset menu including at least one of
a transmission setting unit to preset transmission data for transmitting the first region to the reception terminal in response to a transmission data selection by the user;
a display setting unit to preset display data for the second region in response to a display data selection by the user; and
a layout setting unit to preset a layout for the first region and the second region in the distribution image in response to a layout selection by the user; and
display a distribution start input on the information processing apparatus, wherein,
in response to a user activation of the distribution start input,
execute the application on the information processing apparatus, and
generate and transmit the distribution image to the reception terminal, wherein the distribution image transmitted to the reception terminal is different from a view of the application on the information processing apparatus during execution of the application.

2. The information processing apparatus according to claim 1, wherein the transmission setting unit is configured to transmit an image for the first region having different aspect ratios, resolutions, or frame rates, from that of the view of the application on the information processing apparatus during the execution of the application.

3. The information processing apparatus according to claim 1, further comprising:
a control unit configured to display an image having an aspect ratio that is displayed in an entire region of a two-screen display unit of the information processing apparatus during execution of the application, and
wherein the transmission setting unit is configured to transmit an image for the first region having an aspect ratio that is displayed on a one-screen display unit.

4. The information processing apparatus according to claim 1, further comprising a storage unit configured to store information set by the user for the distribution image.

5. The information processing apparatus according to claim 1, wherein the layout setting unit is to preset a vertical layout and a horizontal layout for the distribution image in response to a vertical layout selection and a horizontal layout selection by the user.

6. The information processing apparatus according to claim 5, wherein the layout setting unit is configured to display a plurality of different vertical layouts for a user to select and a plurality of different horizontal layouts for the user to select.

7. The information processing apparatus according to claim 5, wherein the information processing apparatus is configured to:
generate and transmit the distribution image having the horizontal layout on condition that the information processing apparatus is horizontally oriented, and
generate and transmit the distribution image having the vertical layout on condition that the information processing apparatus is vertically oriented.

8. The information processing apparatus according to claim 1, wherein the layout setting unit is configured to display a plurality of different layouts for a user to select.

9. The information processing apparatus according to claim 1, wherein the preset menu is configured to process at least one of text in the first region, the second region, and a background in the first region.

10. The information processing apparatus according to claim 1, wherein the preset menu is configured to edit text in the second region.

11. The information processing apparatus according to claim 1, wherein the preset menu further includes:
a thumbnail editing unit configured to edit a thumbnail of the distribution image, and
the information processing apparatus is configured to generate and transmit the thumbnail of the distribution image determined according to a user operation on the thumbnail editing unit.

12. The information processing apparatus according to claim 11, wherein the thumbnail editing unit is configured to edit at least one of text in the second region, the first region, and a background of the second region in the thumbnail.

13. The information processing apparatus according to claim 1, wherein the preset menu further includes:
an audio adjustment menu for adjusting audio data for the transmission data, and
the audio adjustment menu is configured to adjust a volume of a sound source unit constituting audio data included in the transmission data.

14. The information processing apparatus according to claim 13, wherein the information processing apparatus is configured to generate and transmit audio data obtained by adjusting a volume of each sound source according to the volume of the sound source unit determined according to a user operation on the audio adjustment menu with the distribution image to the reception terminal.

15. The information processing apparatus according to claim 1, wherein the information processing apparatus is configured to execute image display control to switch from the view of the application on the information processing apparatus during execution of the application to the distribution image in accordance with a view selection by the user.

16. The information processing apparatus according to claim 1, wherein the information processing apparatus is further configured to generate and transmit audio data with the distribution image to the reception terminal.

17. The information processing apparatus according to claim 1, wherein the information processing apparatus is configured to
display a setting menu during transmission of the distribution image for executing setting of the transmission data,
store setting information corresponding to a user operation on the setting menu, and
change setting of transmission data according to setting information stored and transmit a changed distribution image based on changed transmission data.

18. The information processing apparatus according to claim 17, wherein the setting menu during transmission of the distribution image includes an audio adjustment menu for adjusting audio data in the transmission data,
the audio adjustment menu is configured to adjust a volume of a sound source unit constituting audio data included in the transmission data, and
the information processing apparatus is configured to generate and transmit audio data in which a volume of each sound source is changed according to a volume of a sound source unit changed according to a user operation on the audio adjustment menu.

19. An information processing method executed in an information processing apparatus for live streaming an application being used by a user of the information processing apparatus from the information processing apparatus to a reception terminal, the method comprising:
displaying a preset menu to preset a distribution image to be transmitted from the information processing apparatus to the reception terminal before the live streaming is executed, the distribution image including a first region in which the application is to be streamed and a second region in which other information is to be displayed, the preset menu including at least one of
a transmission setting unit to preset transmission data for transmitting the first region to the reception terminal in response to a transmission data selection by the user;
a display setting unit to preset display data for the second region in response to a display data selection by the user; and
a layout setting unit to preset a layout for the first region and the second region in the distribution image in response to a layout selection by the user; and
displaying a distribution start input on the information processing apparatus, wherein,
in response to a user activation of the distribution start input,
executing the application on the information processing apparatus, and
generating and transmitting the distribution image to the reception terminal, wherein the distribution image transmitted to the reception terminal is different from a view of the application on the information processing apparatus during execution of the application.

20. A non-transitory computer readable storage having a program stored therein that when executed by an information processing apparatus for live streaming an application being used by a user of the information processing apparatus from the information processing apparatus to a reception terminal, causes the information processing apparatus to:
display a preset menu to preset a distribution image to be transmitted from the information processing apparatus to the reception terminal before the live streaming is executed, the distribution image including a first region in which the application is to be streamed and a second region in which other information is to be displayed, the preset menu including at least one of
a transmission setting unit to preset transmission data for transmitting the first region to the reception terminal in response to a transmission data selection by the user;
a display setting unit to preset display data for the second region in response to a display data selection by the user; and
a layout setting unit to preset a layout for the first region and the second region in the distribution image in response to a layout selection by the user; and
display a distribution start input on the information processing apparatus, wherein,
in response to a user activation of the distribution start input,
execute the application on the information processing apparatus, and
generate and transmit the distribution image to the reception terminal, wherein the distribution image transmitted to the reception terminal is different from a view of the application on the information processing apparatus during execution of the application.
